(19) United States
(12) Patent Application Publication
(10) Pub. No.: US 2025/0373132 A1
(43) Pub. Date: Dec. 4, 2025

(54) INTRINSICALLY ADAPTING VARIABLE GENERATORS AND MOTORS

(71) Applicant: NextPower360 Co., Leicester, NC (US)

(72) Inventor: Benedetto Anthony IACOVELLI, Leicester, NC (US)

(21) Appl. No.: 19/303,095

(22) Filed: Aug. 18, 2025

Related U.S. Application Data
(63) Continuation of application No. 18/232,959, filed on Aug. 11, 2023, now Pat. No. 12,413,124.
(60) Provisional application No. 63/373,582, filed on Aug. 26, 2022.
(60) Provisional application No. 63/467,850, filed on May 19, 2023.
(60) Provisional application No. 63/467,843, filed on May 19, 2023.

(51) Int. Cl. H02K 16/04

(52) U.S. Cl. CPC H02K 16/04

(57) ABSTRACT

A dynamoelectric machine including a magnet layer to generate a magnetic field, a conductor affixed to the magnet layer, and a yoke radially inward or radially outward from the magnet layer and the conductor. The magnet layer and the yoke have a conical shape with a changing radial thickness along an axis of the dynamoelectric machine. A first axial end of the magnet layer has a smaller diameter than a second axial end of the magnet layer.

### CROSS-REFERENCE TO RELATED APPLICATIONS

The present application is a Continuation of U.S. application Ser. No. 18/232,959, filed on Aug. 11, 2023, which claims domestic priority to U.S. Provisional Applications No. 63/467,850; 63/467,843; and 63/373,582 which were respectively filed on May 19, 2023; May 19, 2023; and Aug. 26, 2022, the entire contents of the above applications are hereby incorporated herein by reference.

### BACKGROUND OF THE INVENTION

### 1. Field of the Invention

The present invention relates to novel structures and systems for improvements to generators and motors. More specifically, the present invention relates to generators and motors that are able to be made smaller, more powerful, and more efficient and able to function better in variable input and operating conditions, such as gusty and widely varying wind speeds, or in changing load and rpm operating conditions of a motor vehicle. These improvements have profound ramifications for power generation (especially in wind power generation) and electric vehicle industries. In power generation, the example embodiments of the present invention are able to harvest more power from a variable input, such as wind, while being smaller, lighter, and more robust. In the electric vehicle industry, the generators and motors of example embodiments of the present invention achieve greater efficiency, range, power density, and improved regenerative braking capacity.

### 2. Description of the Related Art

With the advent of wind power, engineers took the prior art's constant input/constant RPM requiring devices, and put them on top of a tower, adding one of various kinds of turbines to the input shaft. The wind spun the turbine and some electricity was produced, so this was considered a success. However, the input from wind is so highly variable it is the exact opposite of the constant steady input required by the early designs, so they fail to harvest a large portion of the available energy.

In general, a generator faced with the above input would produce little to no power for a significant part of the time that the wind is at lower speeds and would waste most of the available energy when the wind is blowing faster than needed for the ideal RPM. There have been improvements to wind and other generators to improve their function with a variable input. The vast majority are directed to finding ways to waste the energy, sacrificing harvesting efficiency to keep the generator from over-spinning and to match the grid's frequency. A reasonable estimate is that wind generators can waste up to 60 percent of the harvestable energy. Thus, currently available generators can only be feasibly sited in expensive, faraway places with the best wind, such as offshore or on top of a mountain, thus sapping more power due to line loss and limiting feasible sighting options.

There have been efforts to widen the RPM range and tolerance of variable inputs for generators and to improve the range of RPM and load in which motors can function at maximum efficiency, but the improvements have been modest. In the realm of wind power, largely, the alleged improvements simply waste the extra energy of wind that is faster than the generator's ideal speed so it can continue to operate at its lower output.

Active airfoils and responsive braking increase function in variable wind speeds by wasting the extra energy in fast winds. This makes the system much less efficient but keeps the generator operating during fast winds. Likewise, uncoupling the rotor' RPM from the rotor field's RPM in the doubly-fed induction generator (DFIG) systems serves mainly to reduce mechanical stress on the generator by, again, wasting the extra lucrative energy in fast wind. In fact, most of the generator improvements dubbed “variable function” do so by wasting harvestable energy.

### SUMMARY OF THE INVENTION

To overcome the problems described above, example embodiments of the present invention provide new generator systems and structures that instantly and constantly adapt to the variability of the wind.

According to an example embodiment of the present invention, a dynamoelectric machine includes a magnet layer to generate a magnetic field, a conductor affixed to the magnet layer, and a yoke radially inward or radially outward from the magnet layer and the conductor. The magnet layer and the yoke have a conical shape with a changing radial thickness along an axis of the dynamoelectric machine. A first axial end of the magnet layer has a smaller diameter than a second axial end of the magnet layer.

In another example embodiment of the present invention, a dynamoelectric machine includes a rotating structure including connected layers of ferrous material and electrically conductive material. The ferrous material is provided radially adjacent to the electrically conductive material. The rotating structure has a conical shape with a changing radial thickness along an axis of the dynamoelectric machine. A first axial end of the rotating structure has a smaller diameter than a second axial end of the rotating structure.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

FIG. 1 shows a Stator magnet arrangement according to an example embodiment of the present invention.

FIG. 2 shows an end view of FIG. 1.

FIG. 3 shows a multi-layer stator according to an example embodiment of the present invention.

FIG. 4 shows various stator fields including: (A) radial fields and close magnets according to an example embodiment of the present invention, (B) permanent magnet and long, longitudinal field of a conventional machine, (C) induction/squirrel cage, DFIG, arcing long field of a conventional machine, (D) 4 arcing fields of a conventional DC machine.

FIG. 5 shows alternating polarity radial fields according to an example embodiment of the present invention.

FIGS. 6A-6F show hybrid permanent magnet/electromagnet configurations according to example embodiments of the present invention.

FIG. 6G shows another example embodiment of a stator according to an example embodiment of the present invention.

FIG. 7 shows a sectional side view of a dynamoelectric machine according to an example embodiment of the present invention.

FIG. 8 shows a side cross-section view of a dual rotor/triple layer stator configuration according to an example embodiment of the present invention.

FIG. 9 shows various possible rotor configurations according to an example embodiment of the present invention including: (A) a solid/monolithic rotor core, (B) a segmented rotor core, (C) bar segments defining a rotor core, (D) a multilayered rotor core, (E) a radially curved or diagonal bar rotor core with or without interspersed ferrous longitudinally laminated bar segments, and (F) an embedded wire rotor core with or without ferrous material interspersed in, or composing, the binder.

FIG. 10 shows additional possible rotor configurations according to an example embodiment of the present invention including: (G) a thin walled bar segmented rotor core without ferrous component to minimize inter-magnetary distance, (H) a ferrous alloy rotor core with material such as copper etc., (I) a rotor core with material such as copper interspersed with generally longitudinal, electrically insulated ferrous segmented laminated sections, (J) interspersed, electrically insulated ferrous laminations of a rotor core defined by circumferentially contiguous laminations connected on the inner surface of the rotor, (K) interspersed ferrous laminations of a rotor core defined by circumferentially contiguous, electrically insulated, laminations connected on the outer surface of the rotor, (L) interspersed ferrous laminations of a rotor core defined by circumferentially contiguous, electrically insulated laminations connected on the inner and outer surface of the rotor, (M) a ferrous material rotor core in an isolated insulated, generally radial perforations of the rotor, (N) a rotor core with thin rotor bars with ferrous material deposited in thin film, longitudinally separated segmented coatings on one or more surfaces, (O) a ferrous material rotor core defined by circumferentially contiguous electrically insulated rings that traverse back and forth from the inner and outer walls of the rotor.

FIG. 11 shows additional possible rotor configurations according to an example embodiment of the present invention including: (P) ferrous materials embedded, in a uniform or substantially uniform, generally radially oriented or aligned oblong or filamentous particles, inclusions particles, fillings, strips, etc. and (Q) ferrous material and conductive material such as, for example, copper or thin film silver disposed in concentric layers, interspersed with layers of ferrous or other suitably highly magnetically permeable material.

FIG. 12 shows stator cylinders with different strength segments and creating different strength magnetic sections of the inter-magnet stator field according to an example embodiment of the present invention.

FIG. 13 shows varied inter-magnet distances achieved in three different ways according to example embodiments of the present invention.

FIG. 14 shows a frustum stator according to an example embodiment of the present invention in: (A) a side perspective view and (B) a side cross-sectional perspective view.

FIG. 15 shows a stator frustum according to an example embodiment of the present invention including assembled longitudinal wedge pieces.

FIG. 16 shows a stator including latitudinal wedge sections without spacers according to an example embodiment of the present invention, in which longitudinal seams are preferably diagonal and staggered to prevent longitudinal weak areas in the field.

FIG. 17 shows a stator according to an example embodiment of the present invention with alternating adjacent longitudinal wedge segments magnetized with opposite polarity.

FIG. 18 shows a stepped gradient stator according to an example embodiment of the present invention.

FIG. 19 shows an inter-magnet cross-section space having different thicknesses but the same amount of cross-sectional area in each latitudinal area. Note the lines in the longitudinal section drawing.

FIG. 20 shows end views of the example embodiment of FIG. 19 with an inter-magnet cross-section space having the same amount of cross-sectional area in each latitudinal area. Note the lines in the cross-section section drawing.

FIG. 21 shows a rotor with non-imbedded straight rod bars according to an example embodiment of the present invention.

FIG. 22 shows a few examples of a rotor configurations according to example embodiments of the present invention, including: (A) a solid wall, (B) longitudinal bars, (C) straight, spiral, or diagonal walls, and (D) an embedded wire.

FIG. 23 shows an example of a Gabriel's Trumpet/Torricelli Horn.

FIG. 24A is an end view and FIG. 24B is a side view showing example embodiments of external stator electromagnets of the present invention including.

FIG. 25 shows longitudinally arranged stator electromagnets in an example embodiment of the present invention.

FIG. 26 shows a cross section of a dynamoelectric machine corresponding to an example embodiment of the present invention.

FIG. 27 an exploded perspective view of the dynamoelectric machine shown in FIG. 26.

FIG. 28 shows a cross section of a dynamoelectric machine corresponding to another example embodiment of the present invention.

FIG. 29 shows another cross section of a dynamoelectric machine corresponding to another example embodiment of the present invention.

FIG. 30 is a cross-section diagram of an example embodiment of the present invention which includes a dual rotor and tri-stator configuration with hybrid electro/permanent magnets on the inner and outer stator and only permanent magnets on the middle stator. Permanent magnets in the drawing are preferably adjacent conical frustum segments that are on the rotor side of the permanent magnets with the inner and outer stator electromagnets on the yoke side of the stators.

FIG. 31 shows examples of rotor configurations according to example embodiments of the present invention.

FIG. 32 shows a cross section of a dynamoelectric machine corresponding to another example embodiment of the present invention.

FIG. 33 shows another cross section of a dynamoelectric machine corresponding to another example embodiment of the present invention.

FIG. 34 shows another cross section of a dynamoelectric machine corresponding to another example embodiment of the present invention.

FIG. 35 shows another cross section of a dynamoelectric machine corresponding to another example embodiment of the present invention.

FIG. 36 shows another cross section of a dynamoelectric machine corresponding to another example embodiment of the present invention.

FIG. 37 shows another cross section of a dynamoelectric machine corresponding to another example embodiment of the present invention.

### DETAILED DESCRIPTION OF EXAMPLE EMBODIMENTS

Example embodiments of the present invention will now be described with reference to the Drawings.

Example embodiments of the present invention are usable for electric motor applications as well as generator applications. In the electric motor field, motors function at their peak efficiency at a fixed RPM and load value specific to each design. This is ideal when the motors are part of a system such as running a conveyor belt at a specific speed and with a steady load. Design engineers just choose the right kind and size of motor for the application and it will always run efficiently. But if either the load or the RPM of the motor changes, the motor moves out of its highest efficiency range thus reducing range and power.

Similarly, in the electrical generator field, generators are typically structured such that they output a peak power at a predetermined rotational frequency. This rotation frequency is typically chosen based on a desired AC power frequency such as, for example, 60 Hz. When an input rotation speed to the generators exceeds that which is required to output the peak power at the predetermined rotational frequency, then the rotating speed of the generator is reduced through braking or other mechanisms. This braking operation results in a large efficiency loss, as the generator is not able to use all of the energy provided by the input rotation speed.

### First Example Embodiments

First example embodiments of the present disclosure provide novel improvements which are directed towards increasing the magnetic field strength, organization, and effectiveness, and include a family of generally cylindrical embodiments, which are developed into conical embodiments in the next section. While the example embodiments are depicted with generally cylindrical shapes, it is noted that the technical features of these example embodiments are also applicable to multi-layer disk and multi-layer drum shaped arrangements or any other homopolar structures. Because the completed device involves a series of innovations that build on the ones before, they will be described sequentially starting with the most simple, basic permutation, and then building on previous permutations. The improvements generally fall into at least one of two categories. The first is improving magnetic field function and strength, the second is improving the generator/motors adaptability to function well with a wide range of variable input forces.

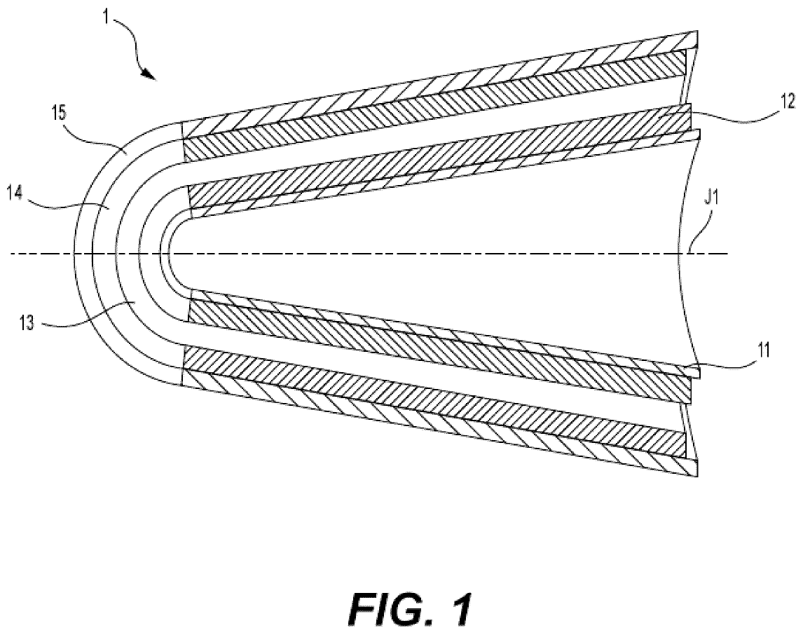

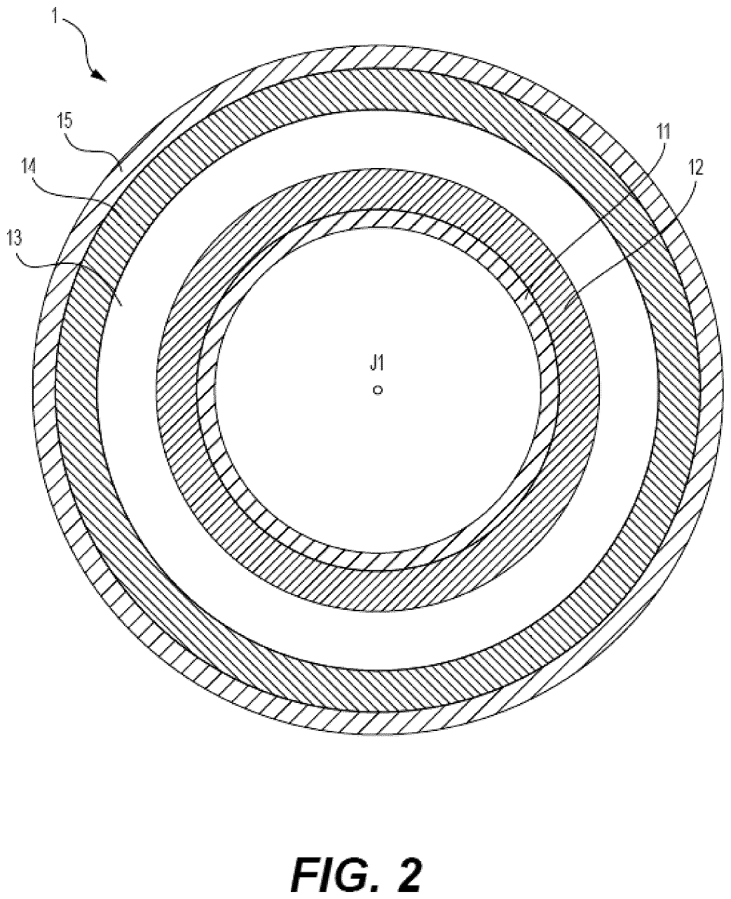

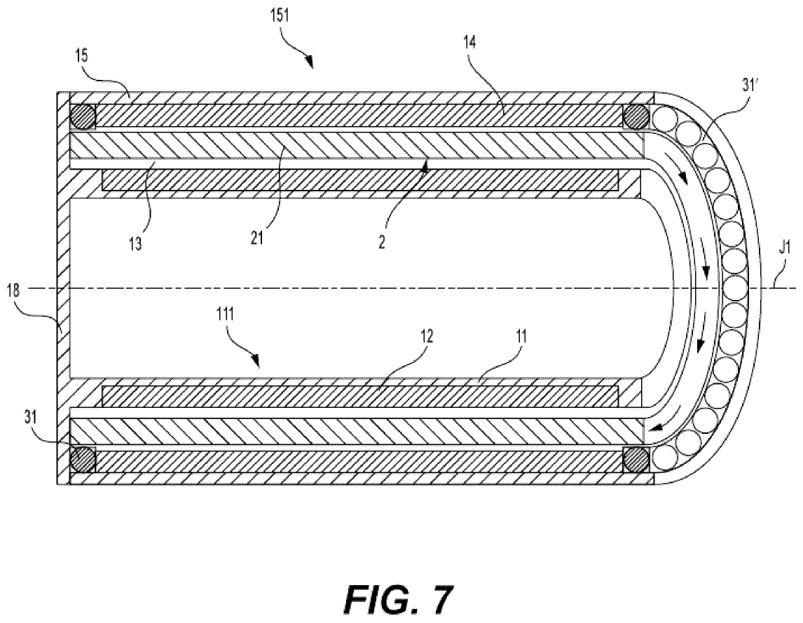

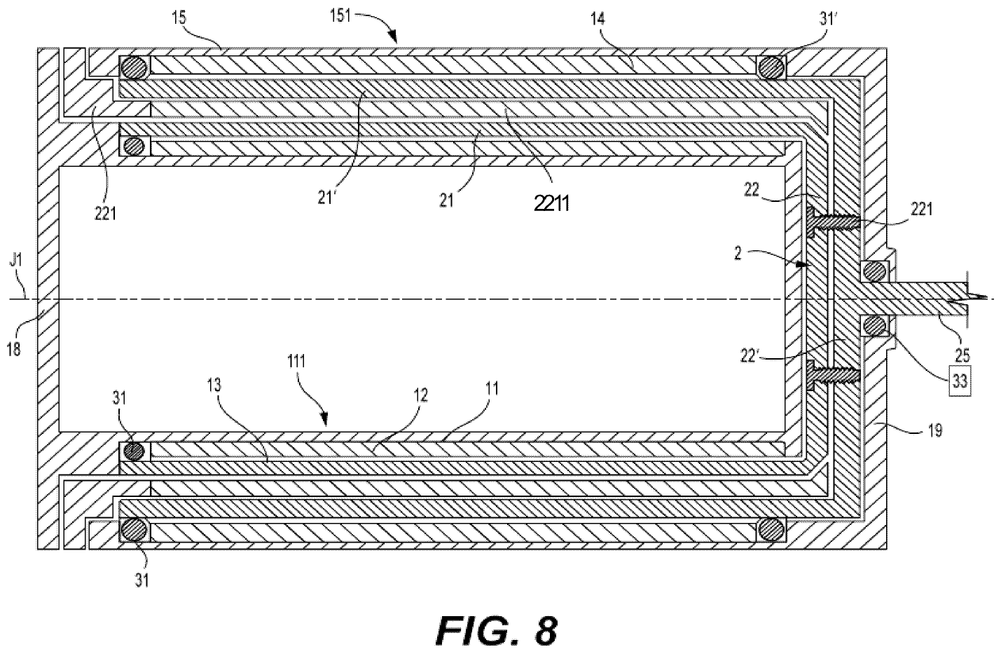

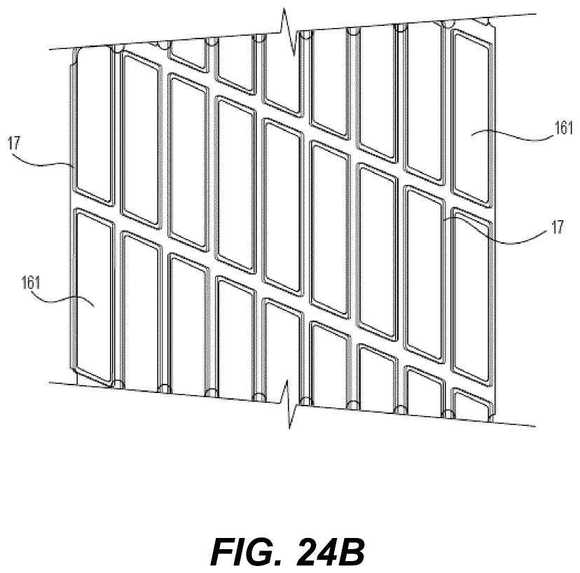

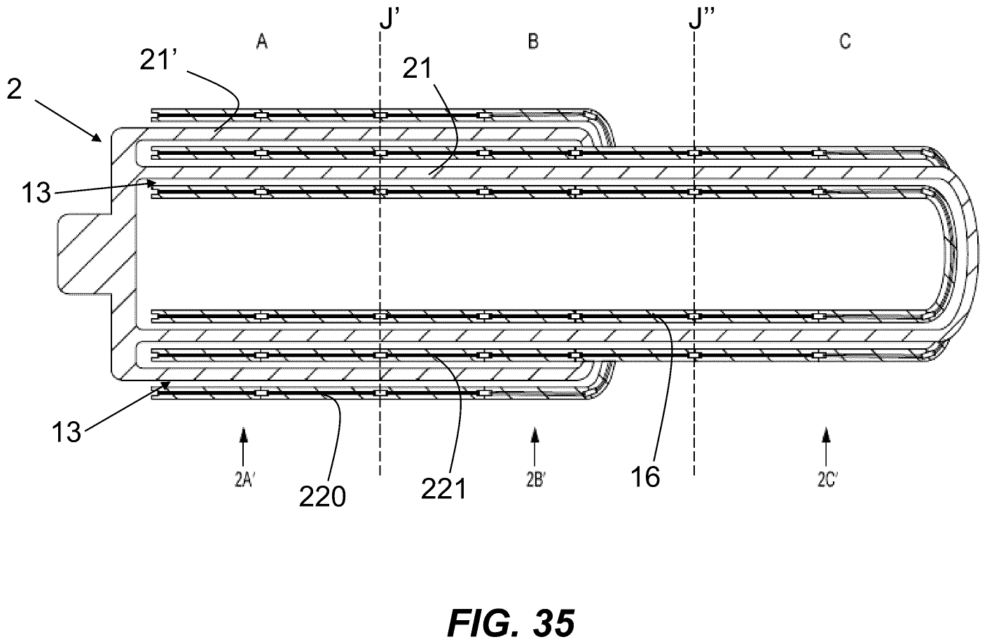

In the family of novel example embodiments described herein, the new stator will preferably include a minimum of 2, different diameter, concentrically nested, stator magnet layers (See FIGS. 1, 2, 7, 8, 12, 13, 18, 19, 21-25, and 30-32). In some other example embodiments, there will be additional stator layers between the levels of the multi-layer rotors (see, for example FIGS. 8 and 35).

As shown in FIG. 1, a stator assembly 1 according to one example embodiment of the present disclosure includes at least an inner yoke 11 with an inner permanent magnet 12 and an outer yoke 15 with an outer permanent magnet 14 which are concentrically positioned and define a hollow cylindrical or frustum air gap 13 (or magnetic flux region) between them in which a rotor assembly rotates. The inner permanent magnet 12 and the outer permanent magnet 14 are generally radially magnetized, usually, with opposite poles facing each other across the space between the concentric layers of the inter magnet air gap 13, i.e., they can be north outside/south inside or they can both be south out, north in.

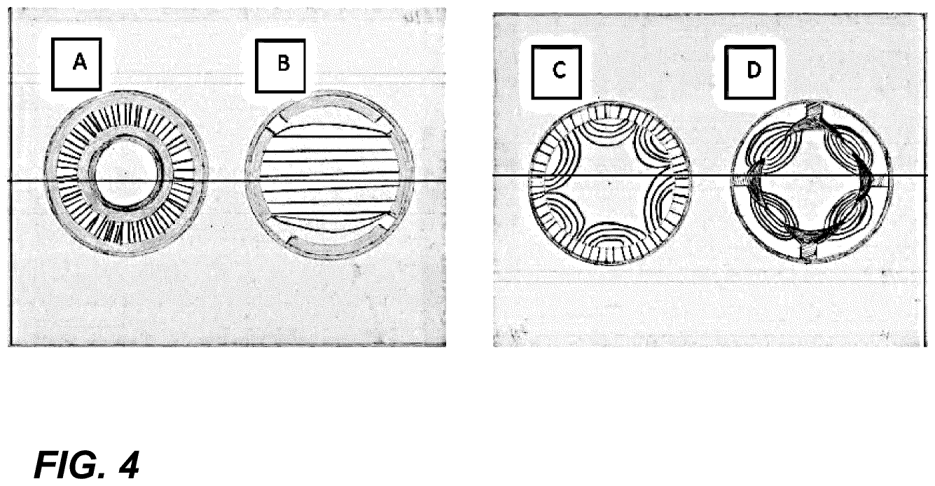

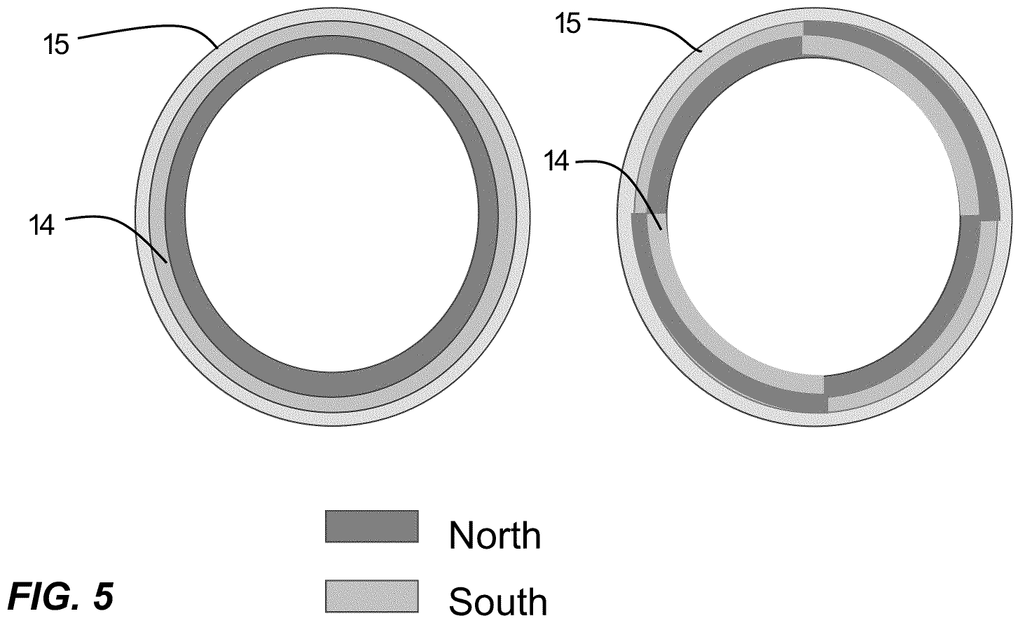

Generally, the air gap 13 contains the powerful inter-magnet radial field(s) as represented by (A) in FIG. 4 throughout the entire length and annular volume. This is in contrast to prior art stators which, as shown in (B), (C), and (D) of FIG. 4 generally either arc across the diameter of the stator or from the stator ring and back to a different spot on the outer ring that is not directly across.

Stationing the magnets (e.g., the inner permanent magnet 12 and the outer permanent magnet 14) in accordance with example embodiments of the present disclosure increases field strength due to magnet proximity, preventing field bulging and avoiding cross-fielding as described below.

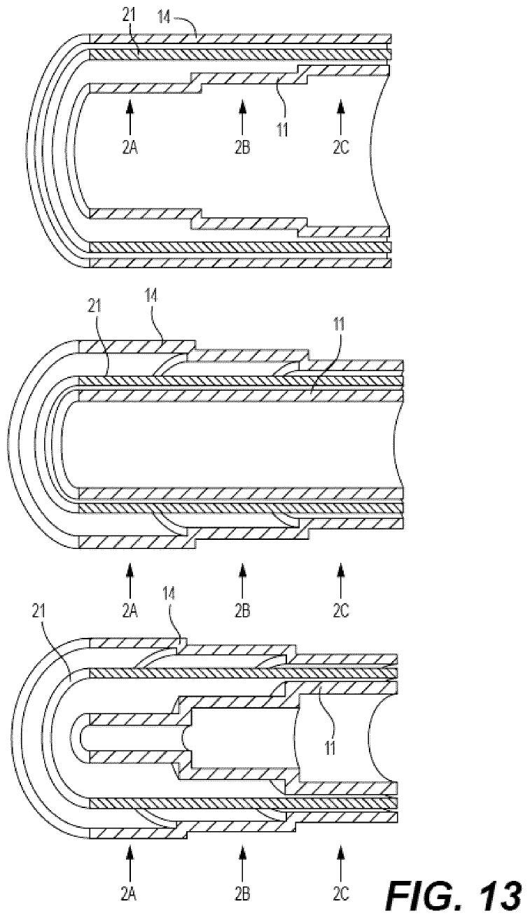

The inter-magnet airgap(s) 13 in most example embodiments of the present disclosure is/are structured just wide enough to hold the body of the rotor 2 (discussed elsewhere in this specification) with a minimal gap on either side to prevent rubbing. But, as described below there are some example embodiments wherein the stators (e.g., 11 and 15) and rotor(s) 2 have areas with increased or gradient changes of gap width (see, e.g., FIG. 13).

FIGS. 1, 2, and 7 show the general components of first example embodiments of a dynamoelectric machine of the present invention. The dynamoelectric machine preferably includes a rotor 2 which is opposed to a stator assembly 1 which includes two opposing stator yokes 11 and 15, upon which are, respectively, inner stator magnet 12 and outer stator magnet 14 magnetized in a radial direction with an airgap 13 therebetween. All of the rotor 2 and the stator magnets 12 and 14 and the yokes 11 and 15 preferably have conical or cylindrical shapes. The rotor 2 may include conductors 21 (preferably linear conductors) which are structured to rotate with respect to the stator yokes 11 and 15. The stator yokes 11 and 15 include magnets (preferably permanent magnets 12, 14 and/or electromagnets 16, 220) which generate magnetic fields in the airgap 13 through which the conductors 21 of the rotor 2 rotate.

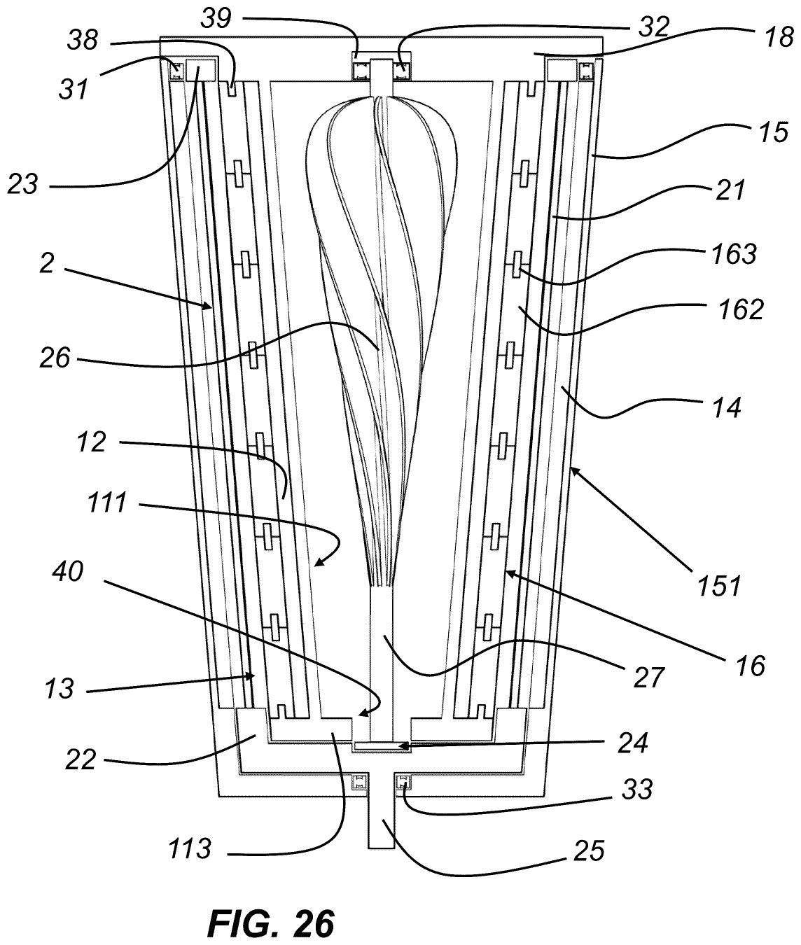

The dynamoelectric machine in FIG. 26 preferably further includes a fan 26 located in a central tube 111 of the inner yoke 11. The fan 26 preferably has a spiral shape, and includes a fan shaft 27 which is fixed to the rotor 2 through a rotor fixing point 24 to rotate together with the rotor 2. The fan 26 generates an airflow to cool the components of the dynamoelectric machine.

The rotor 2 preferably includes a upper rotor ring 23 and rotor support frame 22 which are provided on opposing axial ends of the rotor conductors 21. An upper rotor bearing 31 is preferably provided between the upper rotor ring 23 and the outer stator 4. The rotor support frame 22 preferably includes an integrally provided drive shaft 25 which, in the case of a generator, receives a rotational input to rotate the rotor 2, and which, in the case of a motor, outputs a rotational force to drive an attached member.

As shown in FIG. 26, the inner yoke 11 preferably includes housing upper end 18 and a lower support plate 113 which are provided on opposing axial ends of the inner yoke 11. The inner yoke 11 is structured to support an inner radial surface of the inner permanent magnet 12 (which could be a permanent magnet, an electromagnet, or a hybrid permanent/electro magnet). The housing upper end 18 and the lower support plate 113 both preferably include linking tabs 38 which are structured to support axial portions of the inner electromagnet stator 16. The housing upper end 18 preferably includes a recess 39 which houses an upper shaft bearing 32 which rotatably supports an upper end of the shaft fan shaft 27. The lower support plate 113 preferably includes an opening 40 through which a lower end of the fan shaft 27 extends. The lower end of the fan shaft 27 is preferably affixed to a rotor fixing point 24 defined in the rotor support frame 22. The rotor fixing point 24 may include a recessed structure extending into the rotor support frame 22 and the lower end of the fan shaft 27 may be attached within the rotor fixing point 24 using, for example, fasteners, adhesives, welding, etc.

The outer stator yoke 15 preferably includes a housing lower end 19. The housing lower end 19 preferably includes a recess 192 which houses a lower shaft bearing 33 and an opening 193 which permits the driving shaft 25 to extend out through housing lower end 19. The lower shaft bearing 33 is structured to rotatably support the driving shaft 25. The outer yoke 15 which defines an outer shell 151 of the stator assembly 1. The outer yoke 15 is structured to support a radially outer surface of the outer permanent magnet 14 and to provide a flux path as well as cooling fins.

The inner electromagnet stator 16 preferably includes a plurality of bobbins 162 which are wound with wires of an electromagnet coil 17 and a plurality of linking plates 163 which interconnect adjacent ones of the bobbins 162. In other example embodiments of the present invention, the bobbins 162 may be replaced/exchanged with teeth. Further, the plurality of linking plates 163 may be omitted if coils which are wound on the plurality of bobbins 162 are too large to provide the clearance for the linking plates 163, which may be coils.

In example embodiments of the present disclosure, because the magnetic field is defined by magnets (e.g., permanent magnets 12, 14 and/or electromagnets 16, 220) that are closer to each other, the field is much stronger. With the magnet layout of example embodiments of the present invention, the fields are prevented from bulging the way they do in the conventional structures, making them still stronger, the field is 100% ordered, without cross-fielding or incorrectly orientated sections. A traditionally large, heavy and expensive laminated central rotor core and the laminate stator case are not needed, thus reducing the weight in half. These advantages and the others described in the advantages section, allow the motor and generator to be made smaller, lighter, and more powerful. Better magnetic utilization means less expensive and non-rare earth magnets can be used.

The generally cylindrical configuration requires a novel rotor. Starting with the theoretical simplest example embodiment of the present invention, the rotor can be one, or more than one, generally cylindrical tube(s) of electrically conductive material(s) suspended such that it can rotate within the inter-magnet air gap 13.

This rotor positioning and rotation can be accomplished by various structures including the bearings 31, 31′, 32, and 33 associated with the ends and/or end caps of the stator assembly 1 and the rotor 2. This arrangement creates a significantly higher-efficiency/power rotor. In this most basic permutation, as the rotor 2 turns, the entirety of the inter-magnetic rotor wall (i.e., the rotor conductors 21), throughout its length, circumference, and thickness, transects a radial inter-magnetic field at right angles to the radial field lines. The rotor 2 does this throughout 100% of the rotation duty cycle. There is not another conventional rotor design that achieves that. All other conventional designs have dead zones in the rotor and field relative dead zones in their path of travel, with parts and regions of the rotor that do not contribute to torque or electricity production.

The rotor thickness and inter-magnet air gap space width for each of these permutations is best optimized by balancing multiple factors including stator magnetic field strength range, included ways of fostering the rotors flux conductivity, material's susceptibility to current induction, magnetic permeability/saturation, amperage vs. voltage, expected RPM range, current and voltage loads, cooling requirements, type and amount of ferrous or magnetically permeable material used in the rotor, and need for longitudinal gradient strength in the magnetic field.

Such a simple, elegant, and relatively monolithic type of rotor has several advantages. It can rotate at a very high speed with minimal effect from the vibrations and centrifugal force that would destroy other structures. Virtually its entire mass can be current producing. There are no gaps such as the space between wires in a coil, allowing full use of the EMF active inter-magnet zone. It can be cast, machined, 3D printed or even extruded as a single piece saving manufacturing time, cost, and complexity. It does not require the expense and weight or complexity of a laminated metal core.

In addition to incorporating any combination of the above described attributes, first example embodiments of the present invention are additionally adapted such that the overall shape may become a tapering, generally conical frustum, including layers of similar concentric, but now generally conical, frustum segments. Each of these permutations is combinable with the other permutations to adapt the technology to specific applications.

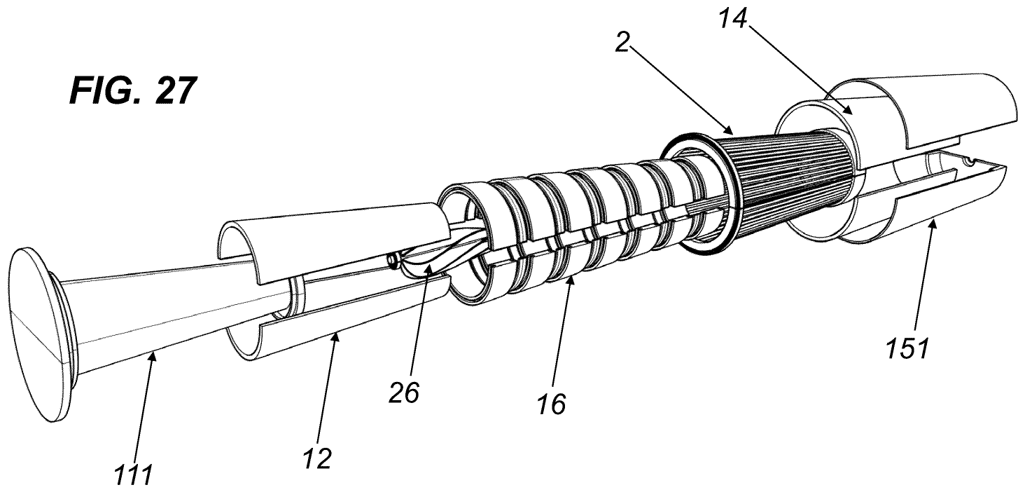

When a frustum is rotated about its central axis (height), all longitudinal points turn at the same RPM. Because points toward the wide end have to go further around their larger circumference in each revolution, they move proportionally faster and farther than points closer to the narrow end. For example, if the wide end had twice the diameter of the narrow end, points at the wide end have to travel twice the distance as those on the narrow end and therefore move twice as fast. In this description, the terms conical, generally conical, and frustum include but are not limited to shapes similar to Gabriel's Horn/Torricelli's Trumpet and convex-sided similar shapes. These terms also cover shapes that function similarly but have the sections arranged with step-wise diameters and/or not by radius gradient change, rather than conical. An example is shown in FIGS. 27, 33, 35, and 40. When referring to shapes such as cones, conical, generally conical, frustum, etc., all generally similar thick walled open-ended hollow structures are being described.

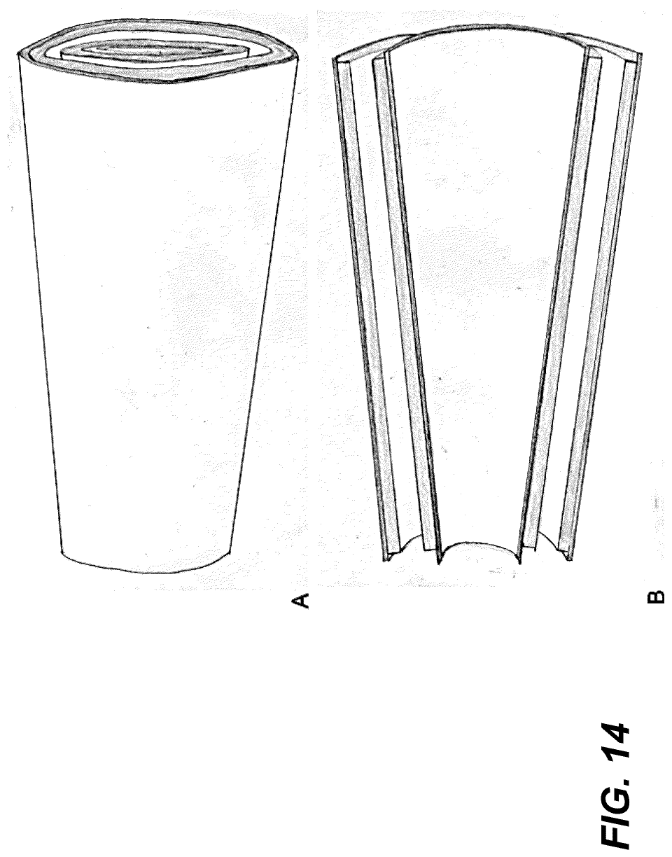

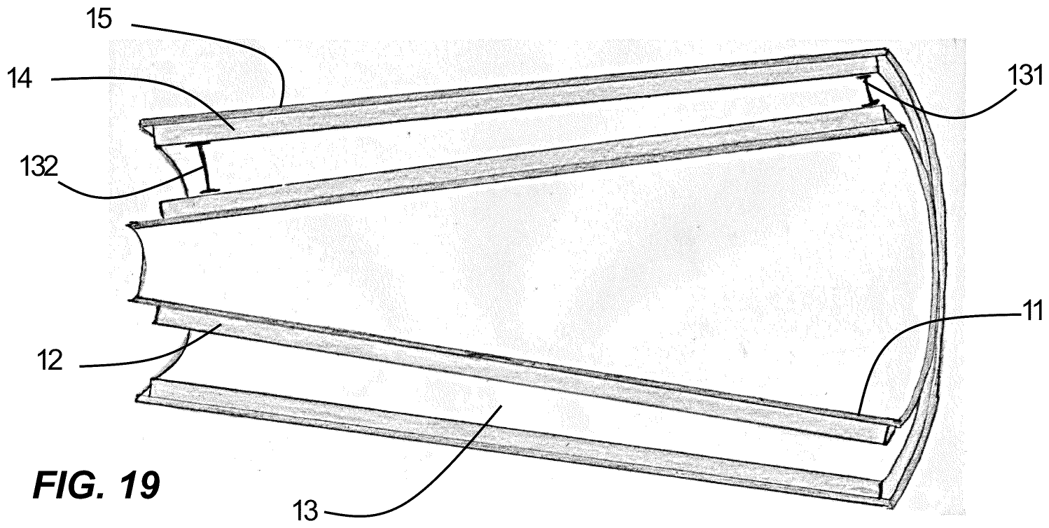

In this series of permutations, the stator preferably includes two or more concentrically nested, radially magnetized generally conical frustum sections, as shown in FIG. 14. The generally conical inner yoke 11, inner permanent magnet 12, outer yoke 15, and outer permanent magnet 14 are arranged such that opposite poles are facing each other across the gap between the two cones. For example, the outer cone may include the outer permanent magnet 14 with a magnetic north facing inward and the inner frustum may include an inner permanent magnet 12 with a magnetic south facing outward, or vice versa. This creates a circumferentially uniform inter-magnet radial magnetic field with the lines oriented like the spokes of a bicycle generally perpendicular to the surfaces of the outer permanent magnet 14 and the inner permanent magnet 12. The outer permanent magnet 14 and the inner permanent magnet 12 cones can be made from a single piece of magnetic material or they can be formed from several magnets machined or shaped to fit together to make such a generally conical structure. Examples of these example embodiments can be seen in FIGS. 19-22.

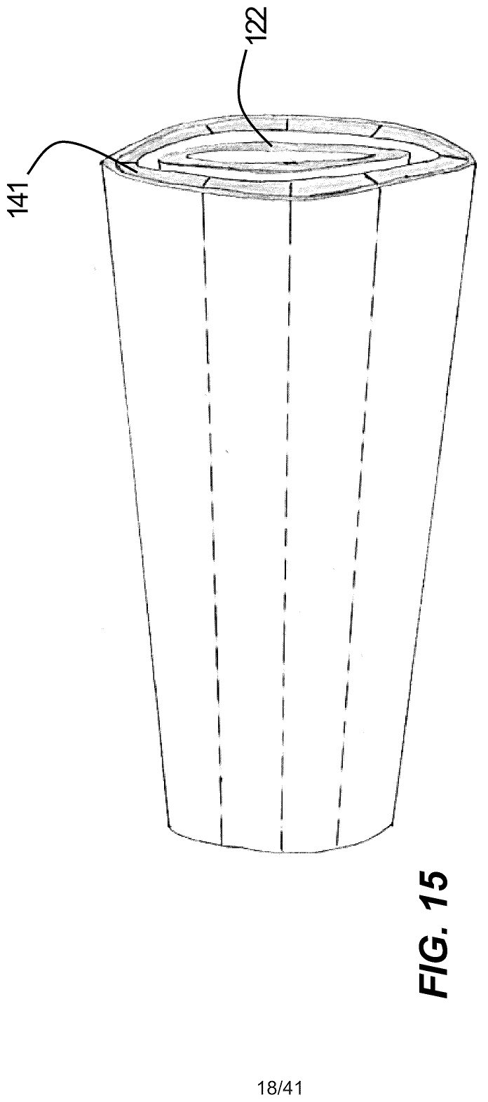

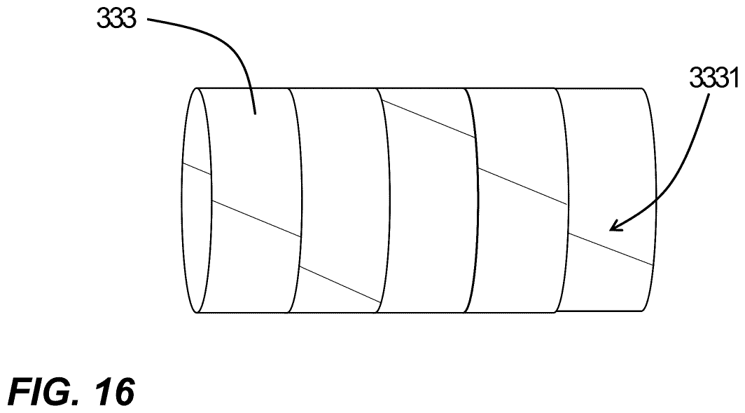

FIG. 15 shows that the outer permanent magnet 14 may be defined by longitudinally extending permanent magnet wedge pieces 141 which are opposed to permanent magnet wedge pieces 122 of the inner permanent magnet 12. FIG. 16 shows an example of a stator assembly 333 which includes latitudinal wedge segments 3331. The latitudinal wedge segments 3331 including diagonal ends which act to prevent longitudinal weak areas in the stator magnet 333.

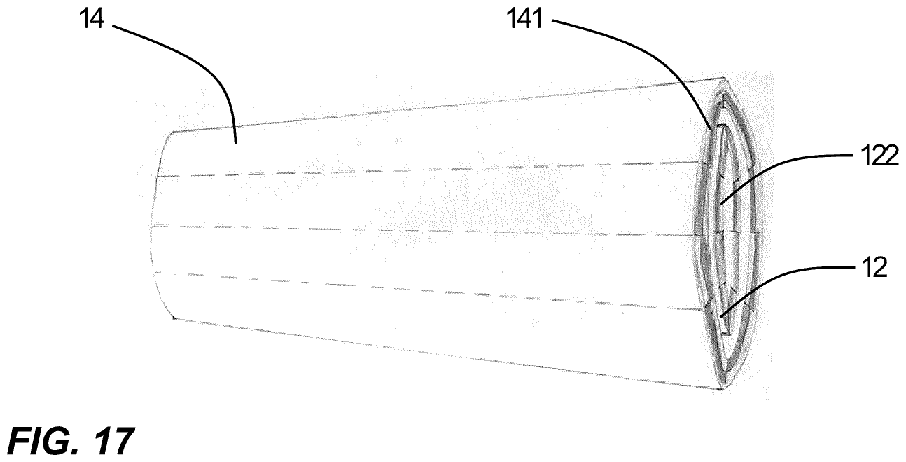

FIG. 17 shows that the outer permanent, electric, or hybrid magnets 14 may be defined by longitudinally extending permanent, electric, or hybrid magnet wedge pieces 141 which are opposed to permanent, electric, or hybrid magnet wedge pieces 122 of the inner permanent magnet 12, with magnetic polarities of opposing wedges of the outer permanent, electric, or hybrid magnets 14 and the inner permanent magnet 12 being reversed.

Stators of example embodiments of the present invention include hybrid electric/permanent magnets. The permanent magnets allow the generator to start up without needing an excitation current, and the electromagnets can be used to selectively augment the field strength as a way of adapting the generative capacity such that the generator can act as a stronger generator or a weaker generator on demand. In fact the electricity that goes into the electromagnets may come from the generator itself so there is the opportunity for it to become not only an adaptable generator, but a self-controlling, automatically adjusting generator. The wind speed changes the RPM which increases the amount of electricity available. A small portion of that electricity is shunted through the electromagnets making the generator stronger so it can handle the higher energy input of increasing wind speed. This also increases the counter torque resistance to further acceleration referred to herein as “generative braking.”

In one example, this can be attained by having a shape that is the same as or substantially similar to a Gabriel's trumpet overall shape that makes the subsequent cut in areas longer so they create equal voltage to the shorter but wider area that cut in first. Another way of equalizing the voltage is to have the narrower diameter segments be longer in proportion to the wider diameter segments as is seen in FIG. 40. Yet another way is by controlling the stator field intensity of each segment.

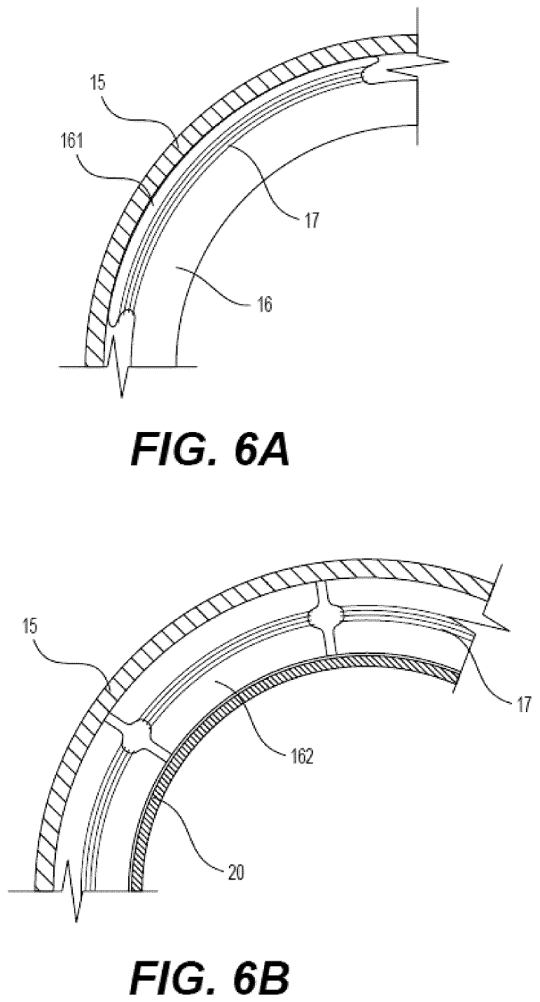

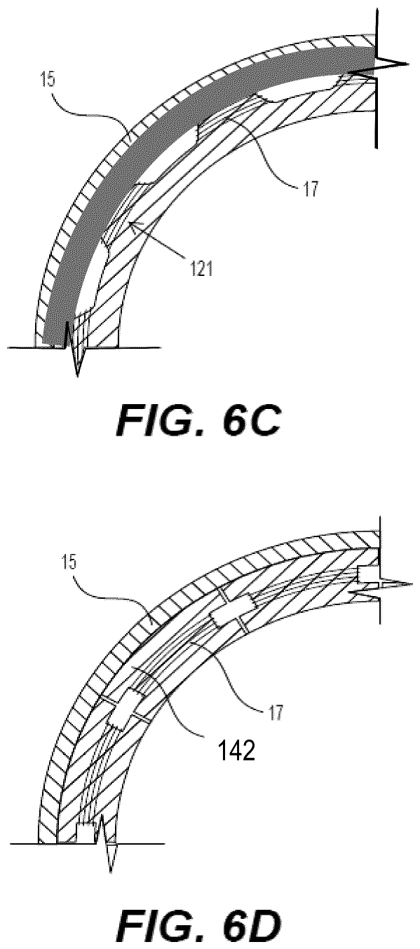

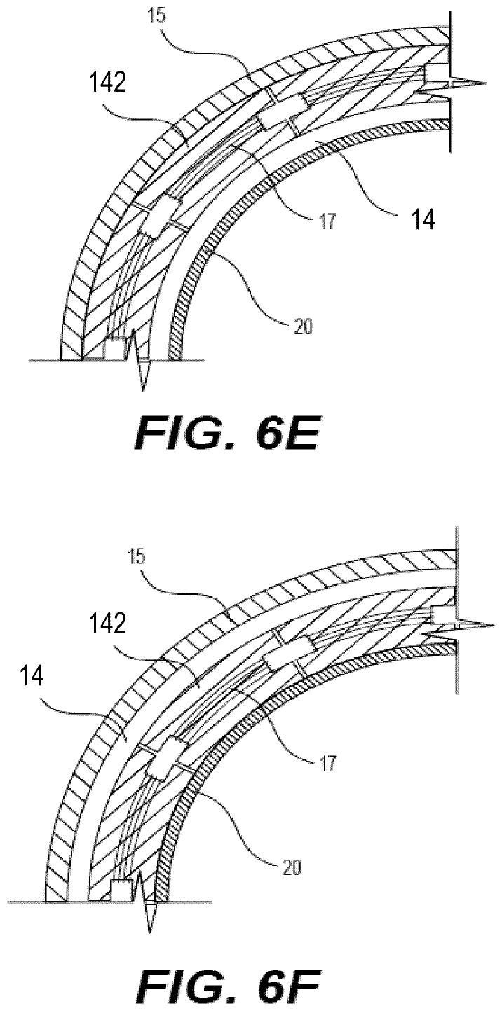

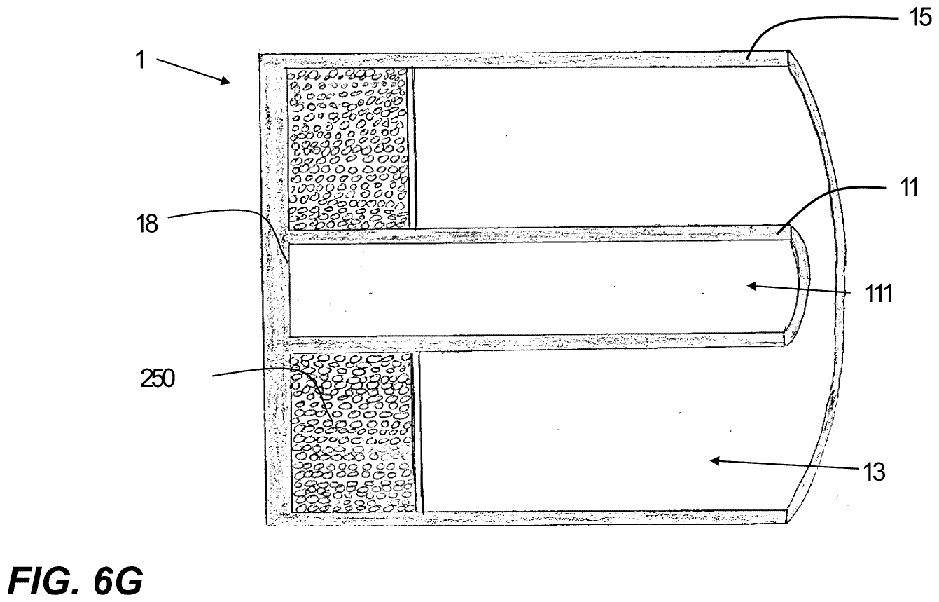

Additional Permutations of the Concentric and Cylindrical Design can be made in accordance with additional example embodiments of the present invention. Some of the example embodiments of the present disclosure include the non-limiting examples below.
Alternative Stator/Rotor Configuration. The generally cylindrical magnets and yokes could rotate, individually or together, as the rotor, and the above described rotor can be the stator. Or both could rotate relative to the other. In the most commonly used example embodiment, the magnets will be stationary, forming the stator and inter-magnet air gap. There may be a non-magnetized buffer zone between the adjacent areas of opposite polarity.
Permanent and Electromagnets. The stators can be permanent magnets, electromagnets, or any combination of either. As shown in FIGS. 6A-6F, the following arrangements could be possible. FIG. 6A shows an outer yoke 15 that includes an electromagnet stator 16 which includes an electromagnet coil 17 wound about a stator projection 161, FIG. 6B shows an outer yoke 15 that includes an electromagnet stator 16 which includes multiple bobbins 162 which are wound with individual electromagnet coils 17 and covered by a ferromagnetic field leveler 20, FIG. 6C shows an outer yoke 15 that includes an outer permanent magnet 12 with outer magnet protuberances 142 which are wound with individual electromagnet coils 17, FIG. 6D shows an outer yoke 15 that includes an outer permanent magnet 12 with outer magnet bobbins 142 which are wound with individual electromagnet coils 17, FIG. 6E shows an outer yoke 15 that includes an outer electromagnet with outer magnet bobbins 142 which are wound with individual electromagnet coils 17 and covered by a ferromagnetic field leveler 20 which is spaced apart from the outer magnet bobbins 142 with a permanent magnet 14 therebetween, and FIG. 6F shows an outer yoke 15 that includes an electromagnet with outer magnet bobbins 142 which are wound with individual electromagnet coils 17 and covered by a ferromagnetic field leveler 20 with permanent magnet 14 between the outer yoke 15 and the outer magnet bobbins 142.

In FIGS. 6C-6F, specially crafted permanent magnet extensions may define and function as electromagnet cores provided the magnets are structured with unsaturated domains. If the electromagnet component is on the rotor side of the outer yoke 15, its ferrous core and coil will be of sufficient size and composition to not saturate unless the electromagnets are at full strength.

FIG. 6G shows an another example of an example embodiment of a stator assembly the present disclosure. The stator assembly 1 in FIG. 6G includes an inner yoke 11 and an outer yoke 15 which are connected through an end 18. The inner yoke 11, the outer yoke 15, and the end 18 may be made from a ferromagnetic material (preferably iron for AC applications and permanent magnet material for DC applications). A lower electromagnetic coil 250 is preferably provided on an inner surface of the end 18 between the inner yoke 11 and the outer yoke 15. A portion of a coil retaining barrier or bobbin 251 is preferably provided on an upper surface of the lower electromagnetic coil 250 to firmly retain the lower electromagnetic coil 250 on the inner surface of the end 18 between the inner yoke 11 and the outer yoke 15. The lower electromagnetic coil 250 is structured to be driven with a current to adject the magnetic flux field of the inner yoke 11 and the outer yoke 15. An inner and outer rotor (not shown) can be respectively inserted between the inner yoke 11 and the outer yoke 15, and within the central tube 111 of the inner yoke 11. The outer yoke 15 preferably corresponds to magnetic south while the inner yoke 11 preferably corresponds to magnetic north, however it is also possible to reverse these polarities if so desired.

As shown in FIG. 31, the tapered rotor 2 is shown with a narrow end facing outward from the drawing. The tapered rotor has been quartered to show different ways to create laminations. Please note that FIG. 31 is for informational purposes only. Actual devices will preferably have the structure of only one of the quadrants in FIG. 27. In the A quadrant of FIG. 31, the rotor 2 is solid and not laminated. In the B quadrant, the rotor 2 is formed of simple laminated tapering bars 211. In the C quadrant, the individual bars 211 are additionally longitudinally split 212 at a point where wideness can cause problems. In the D quadrant, each bar is split three times with the center split 212 going further down the bar 211 than the lateral splits 213.

The thinnest areas of the bars 211 might heat up if they are too small due to the decreased ampacity of the smaller cross-section of metal. This could partially be addressed by making the narrow end radially thicker to give it a greater cross-sectional area. It could also be addressed by giving that area a more robust cooling mechanism. Because the inner air chamber is narrower on the end that would be more apt to heat up, it experiences a greater venturi wind flow which would give it naturally increased cooling. There are permutations where the cooling air enters from that side so it also experiences the coolest air.

The number of bars 211 into which the rotor 2 is split is limited by the ampacity of the narrowest part and the maximum evolved amps. Interestingly, the amount of amperage created depends on the radial thickness of the bar 211, so as the amount of amperage created by the additional thickness of the bar 211, the ampacity also increases.

The preferred radial thickness of the rotor 2 is derived from the balance of a number of factors. The more metal in the magnetic field (up to the point of saturation), the more power that will be evolved. However, when the amount of metal increases, and the distance between the stator magnets (i.e., the air gap) must also be increased to fit the rotor 2, it drops the field in the ratio to the cube of the increased distance. So a balance needs to be achieved between the most metal possible without weakening the field strength beyond the point of diminishing returns.

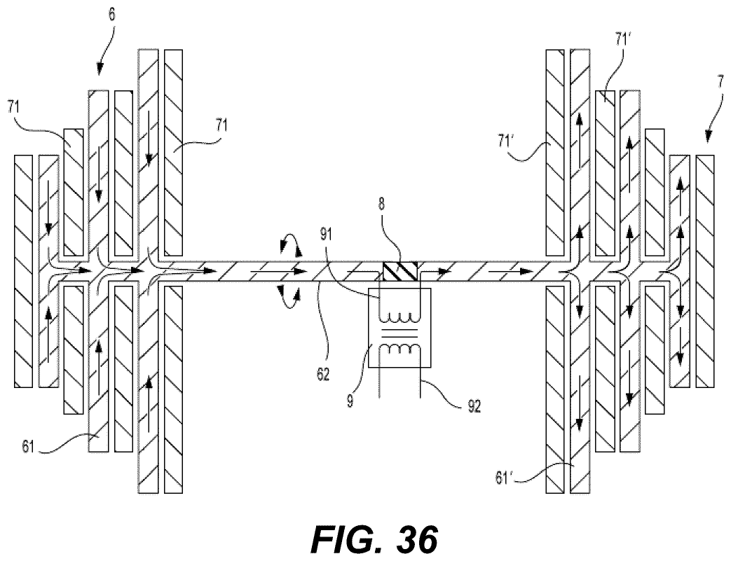

As shown in FIG. 36, there is a permutation of an example embodiment of the present invention which includes a structure and/or circuitry to feed back the current being developed at the negative end of the rotor to its positive end, reminiscent of a power bussing system that can repeat the current's flow through the magnetic field, increasing the voltage each time around. As the voltage passes a certain threshold, it powers electrical collection circuitry including, for example, a step up transformer apparatus, power conditioner, converter circuitry, or inverter circuitry such that the preferred higher voltage and conditioned current can be selectively directed out of the generator.

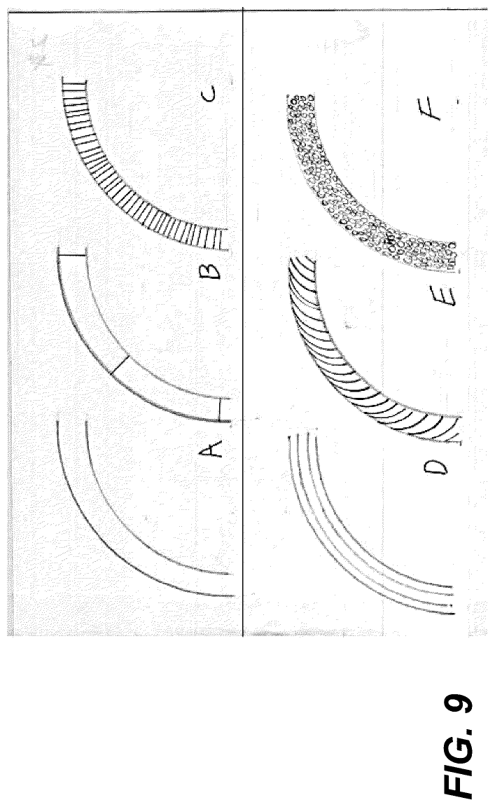

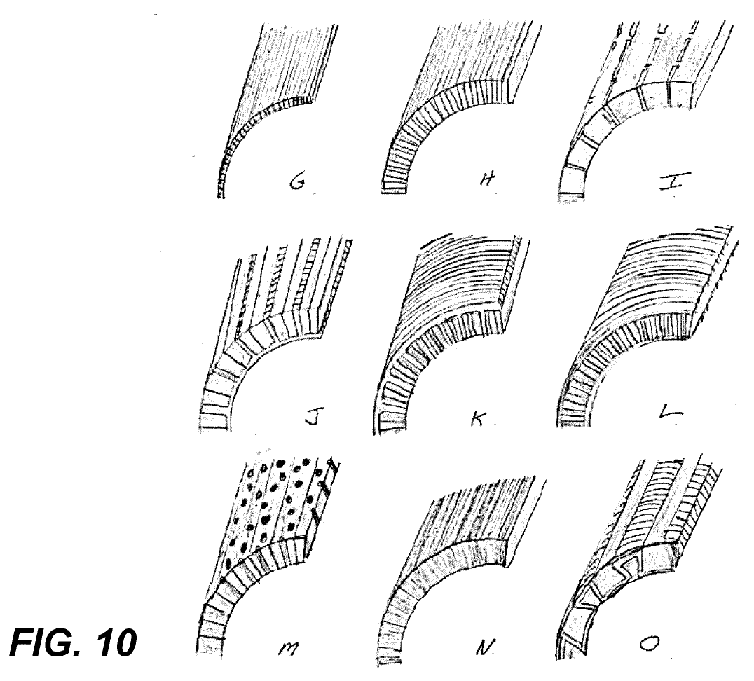

There are various example embodiments of the rotor adapted to specific applications that have the same overall shape but are assembled of different sub-components for various applications (see FIGS. 9 and 10). Rather than a purely monolithic tube, the rotor can be divided into a series of longitudinal, or other, segments, called bars. The segmented coil may have the seams engineered to not align with the longitude of the rotor, called diagonal bar segments. The rotor body may be formed of encased and embedded wires. The segments could have an electrically insulating coating to help prevent electrical backflow.

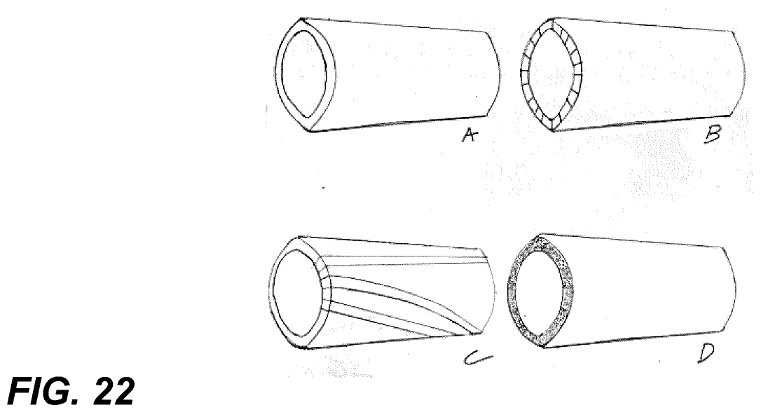

As shown in FIG. 22, the longitudinal segments 211 of the rotor 2 may be straight, diagonal, or spiral, which is useful if avoiding being parallel to magnetic seams of the stator assembly 1, should the stator assembly 1 have seams. The layers may have different internal morphologies including thickness, materials, and segment shapes depending on the needs of the application. AC rotors will be discussed in their own sections.

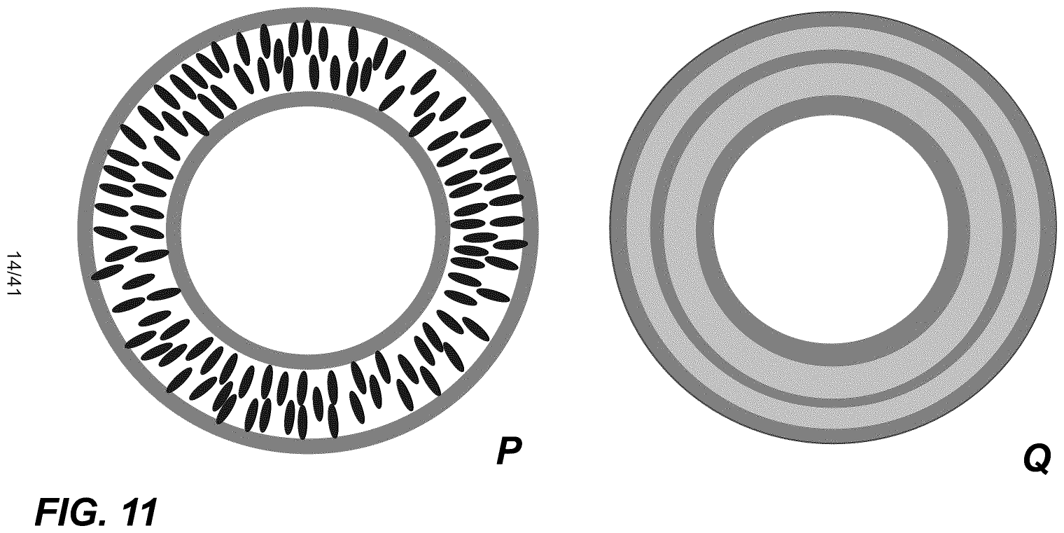

When a thicker rotor is desired, a ferrous or other magnetically permeable material will need to be incorporated into the permanent magnet section of the rotor to allow magnetic flux to conduct through the wall of the rotor in such a way to reduce distance based field loss. This material may be incorporated in a number of ways, illustrative representative fashions are illustrated in (H) through (O) of FIG. 10 and (P) and (Q) of FIG. 11. It is noted that the ferrous, ferromagnetic, or other magnetically permeable materials referenced in this disclosure refers to any desirable material which possesses magnetic permeability, such as, for example, iron, cobalt, nickel, gadolinium, permalloy, molypermalloy, Mu-metal, carbon steel, ferrous stainless steel, ferrous alloys, soft ferrite, etc.

Specifically, FIGS. 9 and 10 show various possible rotor configurations. Portions A-F are directed towards the possible configurations of the rotor bars, and Portions G-Q are directed toward demonstrating various ways ferrous material can be incorporated to increase the rotor's net magnetic permeability to allow for thicker rotors. Specifically, the various portions show: (A) Solid/monolithic, (B) segmented, (C) bar segments, (D) multilayered, (E) radially curved or diagonal bar with or without interspersed ferrous longitudinally laminated bar like segments, (F) embedded wire with or without ferrous material interspersed in the binder, (G) thin walled bar segmented without ferrous component to minimize inter-magnetary distance, (H) ferrous alloy with material such as copper, etc., known to those skilled in the art, (I) material such as copper etc. interspersed with generally longitudinal, electrically insulated ferrous segmented laminated sections, (J) interspersed, electrically insulated ferrous laminations defined by circumferentially contiguous laminations connected on the inner surface of the rotor, (K) interspersed ferrous laminations defined by circumferentially contiguous, electrically insulated, laminations connected on the outer surface of the rotor, (L) interspersed ferrous laminations defined by circumferentially contiguous, electrically insulated laminations connected on the inner and outer surface of the rotor, (M) ferrous material in isolated insulated, generally radial perforations of the rotor, (N) thin rotor bars with ferrous material deposited in thin film, longitudinally separated segmented coatings on one or more surfaces, (O) ferrous material defined by circumferentially contiguous electrically insulated rings that traverse back and forth from the inner and outer walls of the rotor, (P) ferrous materials embedded, in a uniform, generally radially oriented oblong or filamentous particles or inclusions, and (Q) ferrous material and conductive material such as, for example, copper or thin film silver disposed in concentric layers. Further, a thin film silver layer could be deposited over entire external surfaces of the rotor to increase conductivity.

The above novel generator structures of example embodiments of the present invention allow for a generator to be smaller, lighter, simpler, more efficient, and more powerful. The next series of described novel structures allow generators to operate at a much greater range of power inputs than conventional generators by immediately/automatically adapting via intrinsic synergies to become the exactly correct power generator for the input. This makes them especially suited to variable input applications such as wind power or vehicle generators/alternators.

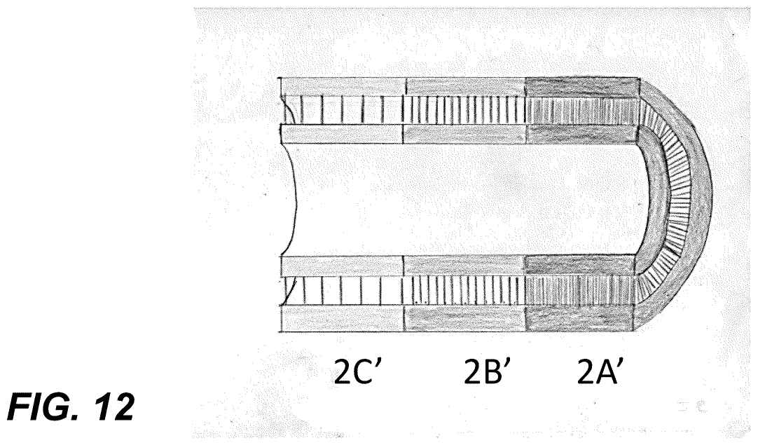

The stator can be fashioned in generally the same shape but with a gradation or variety of circumferential ring segment magnetic field strengths arranged along its longitudinal length. For example, the first cylindrical ring segment of the inner and outer stator can be made with a stronger magnet than the next segment and so on. In FIG. 12, those field variations are shown as different gradient magnetic field strength areas 2A′-2C′ which are arranged by strength with weaker to stronger laid out from left to right.

There can be greater or fewer of the different gradient magnetic field strength areas 2A′-2C′ shown in FIG. 12 based on a desired adaptability parameter. The gradient magnetic field strength areas 2A′-2C′ can be in any order and it can be more of a gradual gradient in field strength than a stepwise progression. The differential magnetic strengths can be procured by varying the magnetization steps or the composition materials used. The segments may be of different field strengths in a number of ways including being made of different magnet materials such as alnico, ceramic and neodymium, etc., or they may be made of different grades or dilutions of magnetic materials, or they can be magnetized to different strengths. They can be made as described in the next section paired with electromagnets to strengthen or weaken the magnetic field or they can be composed of electromagnets powered to different strengths.

In FIG. 12, as the rotor spins, different sections pass through progressively stronger fields. While the entire rotor has the same RPM and the electroactive rotor segments are all moving at the same speed, the different longitudinal rotor areas are passing through magnetic fields of different intensity. This is conceptualized by realizing that each segment of the electroactive rotor segment is transecting a different number of field lines per second. The segment with the strongest field has the most lines per area, so as the coil speed ramps up from too slow an RPM to generate power, only the section of coil with the highest field strength segment first experiences the transaction of enough magnetic field lines per second to induce a current flow. Therefore, the generator acts like a much smaller unit of the conventional type generator. It makes a small amount of power but is relatively easier to spin as less back force is generated to resist the rotation.

Still referring to FIG. 12, as the RPM increases, at a specific RPM a section at 2B′ encounters and transects enough field lines per second to also contribute current, even as the section at 2A′ has an output which also increases. So, as the rotor spins faster, the current output and the EMF resistance to spin also rise in greater than direct proportion to the change in RPM. As the RPM increases further again, the output and needed input torque increase more proportionally until section 2C′ encounters enough field lines per second to also become generatively electroactive. At this point both the electrical output and the force needed to turn the generator jump up again.

Another way to better match the generation power/electrical output seamlessly to the input force and thereby make the generator more able to handle a greater range of input forces is to create areas of varied inter-magnetic space. The magnets could diverge to create a varying inter-magnetic gap, creating areas of differing field strength as in FIG. 13.

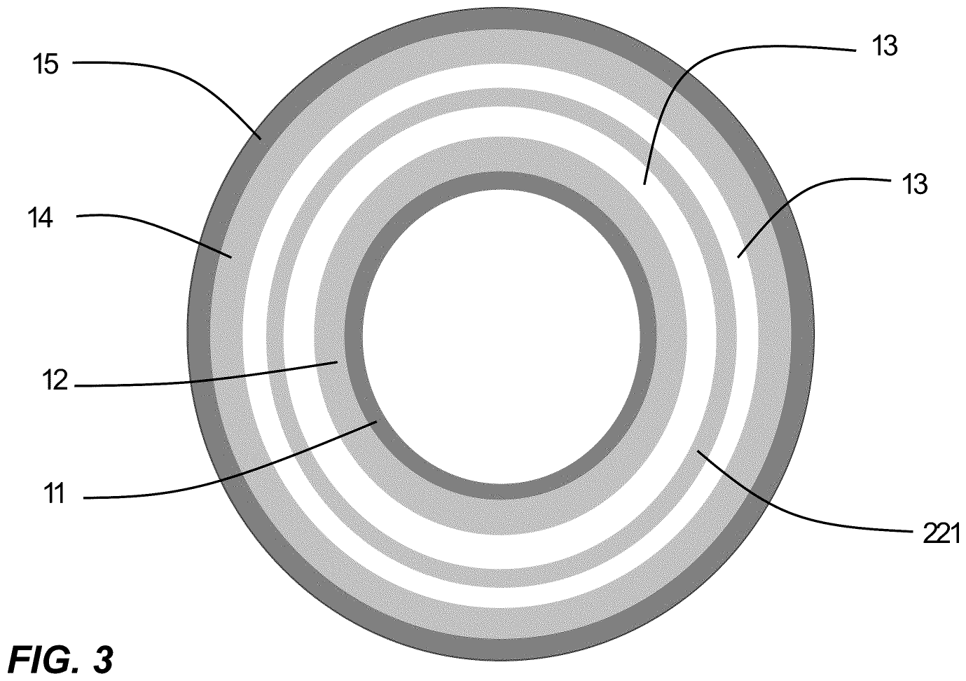

In another additive, roughly cylindrical way of further widening a generator's ability to adapt to a greater range of inputs is to make it a multi-rotor device as in FIGS. 3, 33, and 34-37. Because the outer rotor is moving faster and throughout a larger area, it transects more lines per second and will cut in at a lower RPM than the inner rotor layer. The magnet layers could have different field strengths and or gradient fields to further tune this advantage.

The rotor segments could be collectively bussed together by a current collector at the ends to create a high amperage, low voltage system. The bar segments can be bussed together in a more serial circuit to make a higher voltage/lower amperage output. Different segments can be bussed together for three-phase and AC example embodiments described in later applications. They can be bussed or commutated such that current from one segment is transferred back to a different segment's far end, creating a series circuit to increase the voltage.

In some example embodiments, the individual segments can be serviced, grouped, or excluded by a controller and a series of brushes/commutators. This would be advantageous in AC, three-phase, and direct grid intertie systems.

The stators could be electromagnets with polarity electronically controlled, of variable power, and reversible. The rotor could be longitudinal electromagnets that are polarity controlled, variable electromagnets. In motor applications, the stator could be permanent magnets offset in alternating polarity. The rotor could embody electromagnets that could be activated in a pattern and polarity that cause the rotor to spin. Conversely the longitudinal electromagnets could be in the stator and longitudinal alternating polarity permanent magnets could be in the rotor. The stator magnets could be flash electrified in patterns and polarity to force the rotors' torque. The pattern and speed of the electromagnets can be varied for various torque, loads, and RPM operating conditions to create differing torque or speed or to maximize efficiency. These permutations will be further discussed below.

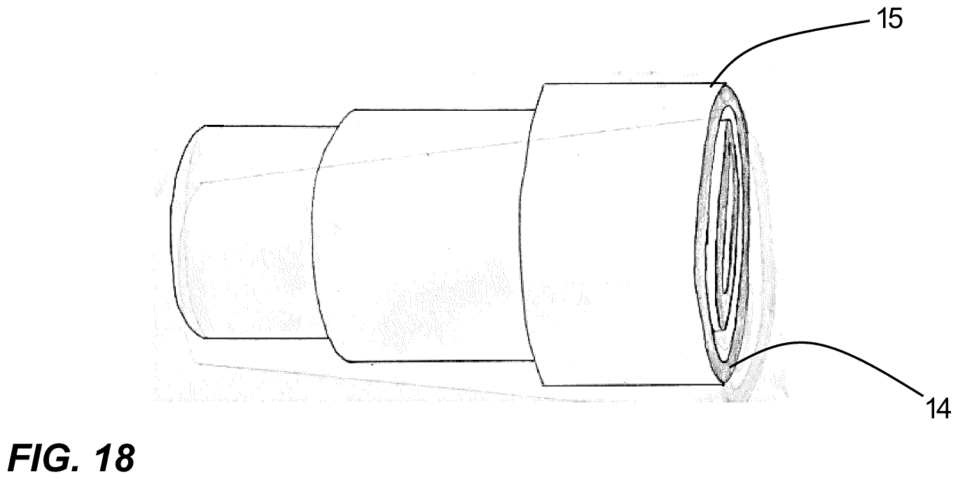

A series of different radius ring, cylinder, or frustum segment magnets can be used to approximate the general conical frustum shape (see FIG. 18).

There are permutations in which the generally conical stator magnet layers have different wall angles to make a tapering inter-magnet space. An example of this would be having the inner walls slightly steeper than the outer stator wall so that the inter-conical space for the rotor is wider on the narrow end of the apparatus than it is on the wide end. This can be stepwise, and/or gradient, or in other arrangements.

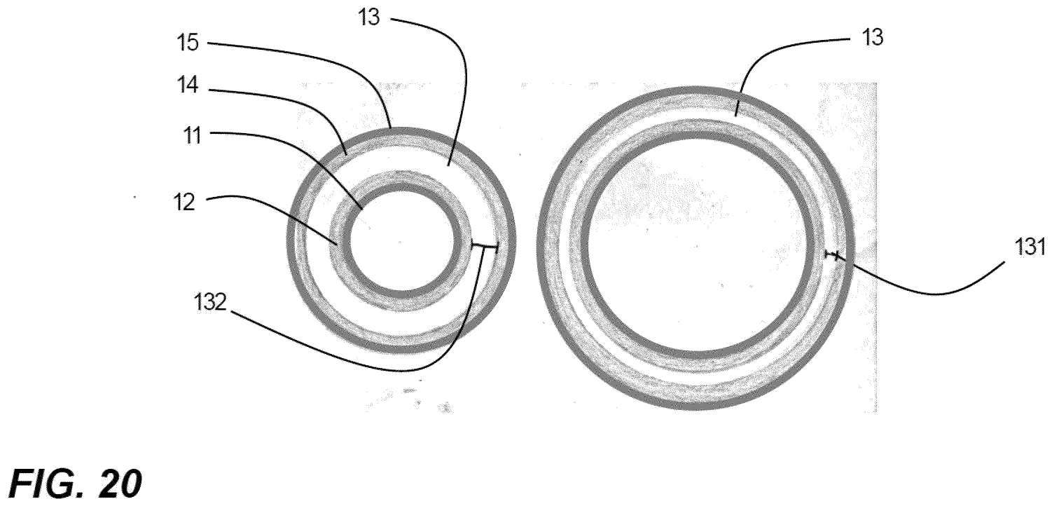

These can be manufactured such that the cross-sectional area of the inter magnet space is preserved throughout the length of the apparatus. Doing so not only maintains an identical cross-sectional volume of the rotor throughout all segments but also adds another way to provide variable input adaptability by providing a wide portion 132 in the inter-magnet space 13 as one approaches the narrow end of the device and providing a narrow portion 131 at the wide end in the inter-magnet space 13 (see FIG. 19 and FIG. 20). This adds the benefit of relatively increasing field strength the closer to the wide end.

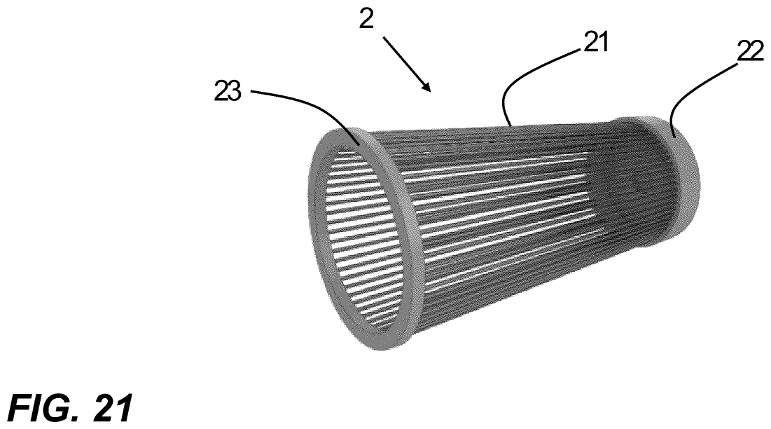

Interposed in the space between the stator magnet layers is the rotor which rotates in this space. There are many permutations of possible rotors according to example embodiments of the present invention. A first possibility would be a solid metal frustum, the body of which is structured to fit within the inter-stator space. Although the uniformity of the field would create less potential for eddy currents than conventional designs, this rotor would still have a degree of deleterious eddy current formation potential. In a second permutation, the rotor body is divided into longitudinal, diagonal, spiral, or other shaped, electrically insulated strips called bars. These are similar to those described in the cylindrical section but modified to the more conical hollow frustum shape. Examples of rotors according to example embodiments of the present invention can be found, for example, in FIGS. 26 and 27. As shown in FIG. 21, a rotor assembly 2 may include a conductor array 21 provided between a rotor support frame 22 and an upper rotor ring 23. Further, as shown in FIG. 22, other examples of rotor configurations according to example embodiments of the present invention, include: (A) a solid wall, (B) longitudinal bars, (C) straight, spiral, or diagonal walls, and (D) embedded wire.

In a permutation, the rotor is defined by a series of wires laid out longitudinally throughout the body of the cone. These may be embedded in a ferro metallic, or possibly ferro metallic infused (or not) plastic, resin, or epoxy substance, or the like.

A sub-permutation of the wire or bar based rotor body would include wires/bars that are close together on the small end of the cone and spread apart on the larger end, or they could taper to fit or converge into fewer wires/bars. There is a permutation of the rotor wherein the wires/bars themselves taper longitudinally such that the small end of the cone has the small or narrow ends of the wires and the large end of the cone has the large ends of the wires.

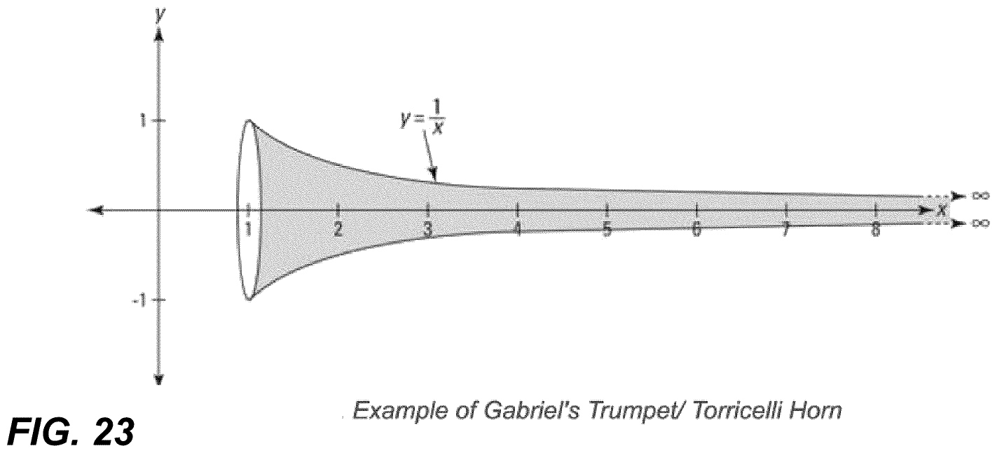

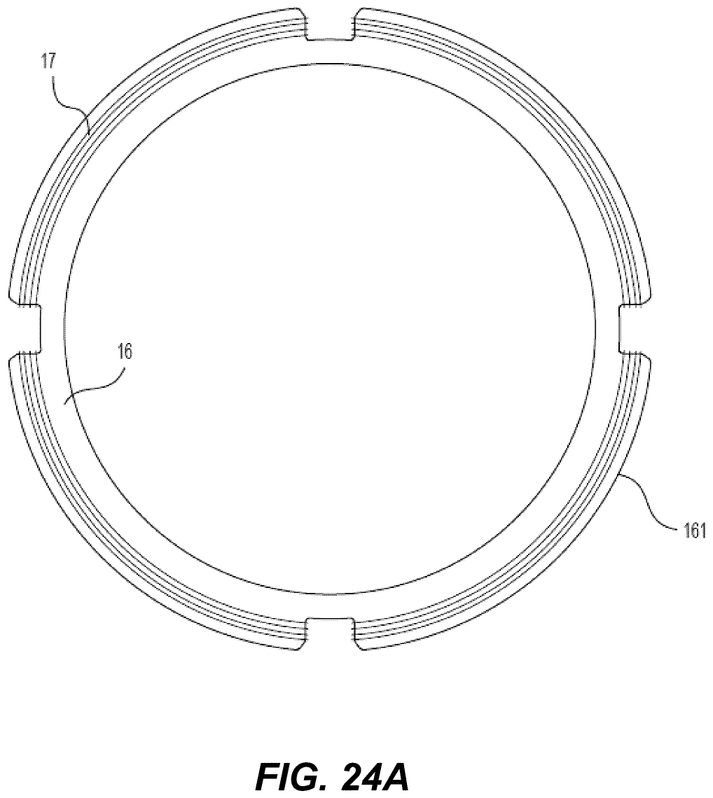

The above permutations can be used with a Gabriel's Trumpet (see FIG. 23) shape or specific length gradient cylinders can be chosen such that the extra voltage expected in the wider sections is proportionally offset by making the narrower sections longer to increase their voltage. This offsets the wider rotor sections making a higher voltage than the narrower, unless the narrower section is proportionately longer, balancing the voltage.

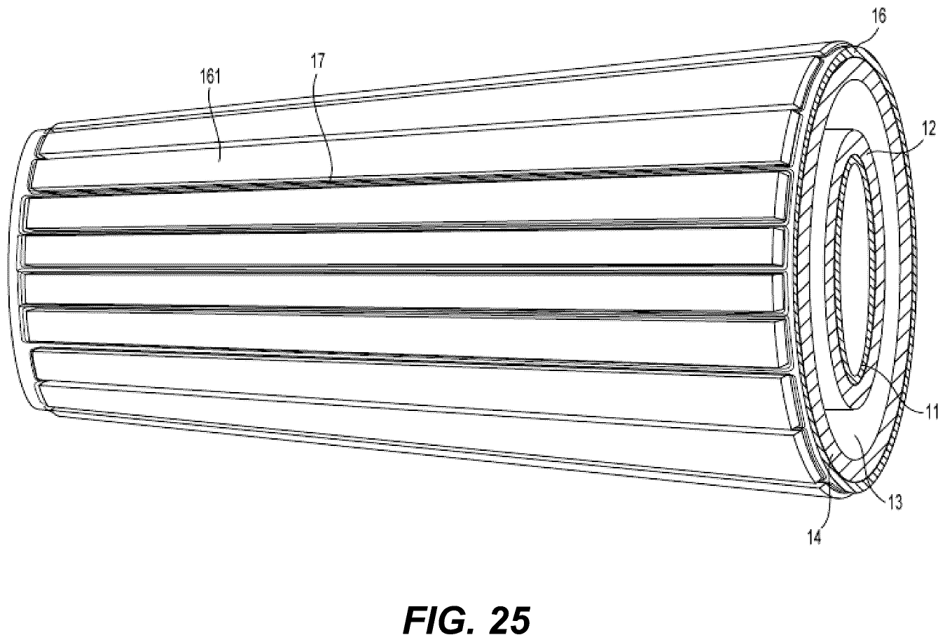

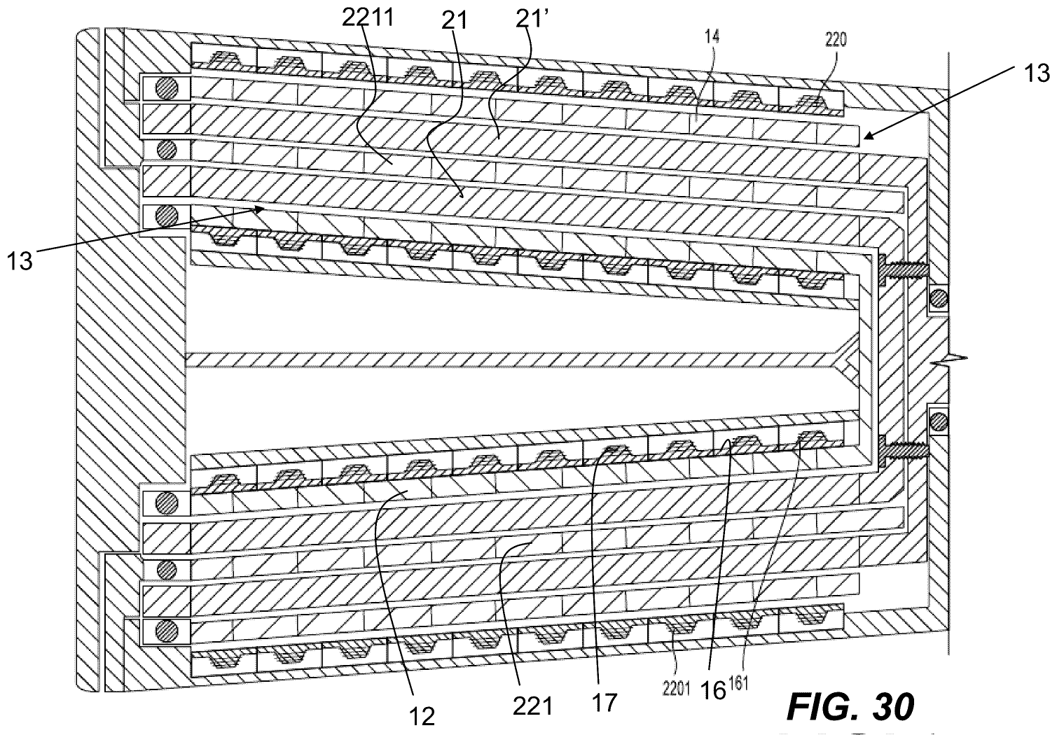

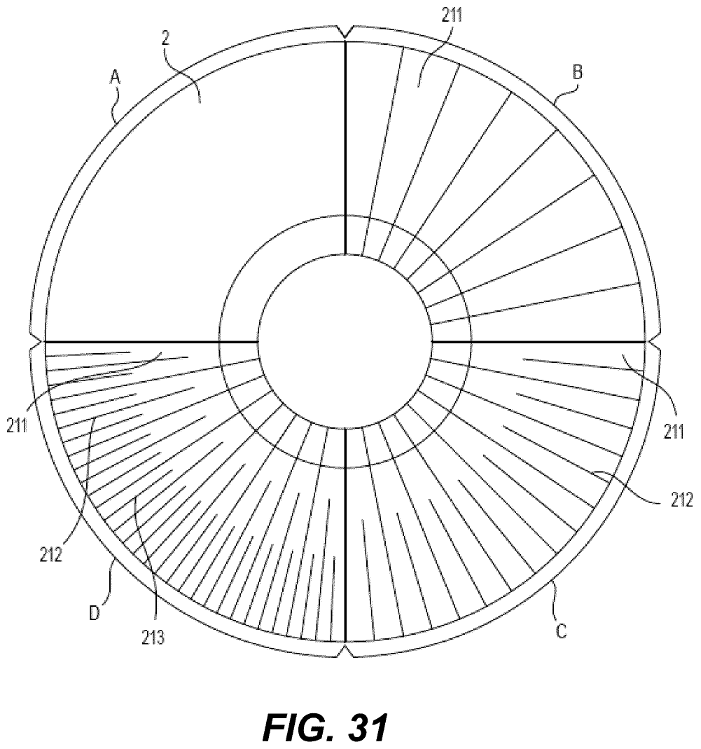

Using a combination of electromagnets functioning synergistically with the permanent stator magnets confers a still greater range of instantaneous and automatic adaptability. There are many possible ways of achieving this. For this conceptualization, a neodymium material is used with an overabundance of the ferrous component such that a powerful magnet is created which is then not magnetized to its strongest potential. That, and the dilutive effects of the extra iron, keep it from being fully magnetically saturated. If this material is used, for instance, in the inner frustum, the outer surface is smooth to allow for a reduced or minimized air gap between the stator wall and the outer rotor face, but the inner stator surface is manufactured with studs, ridges, or rings as protuberances that accept a surrounding electromagnet coil as in portion (C) of FIG. 6 and FIG. 30. Alternatively, the coils can be in spool-shaped indentations around the magnetic segments as in FIG. 30. Another embodiment for delivering uniform, radial electromagnetic flux is seen in FIG. 6G wherein the multiple coils of the previously described designs are augmented or supplanted by a single large coil 250. When energized, the electromagnet field combines with the permanent magnet field to increase or decrease the field strength. In the outer stator magnet, the electromagnet core protuberances could be on the external side as can be seen in FIG. 25, or they can be part of the permanent magnet as in FIGS. 6D-6F or they can be a separate, adjacent structure as in FIG. 25 which shows an array of stator projections 161 on an electromagnetic stator 16 which are wrapped with electromagnetic coils 17.

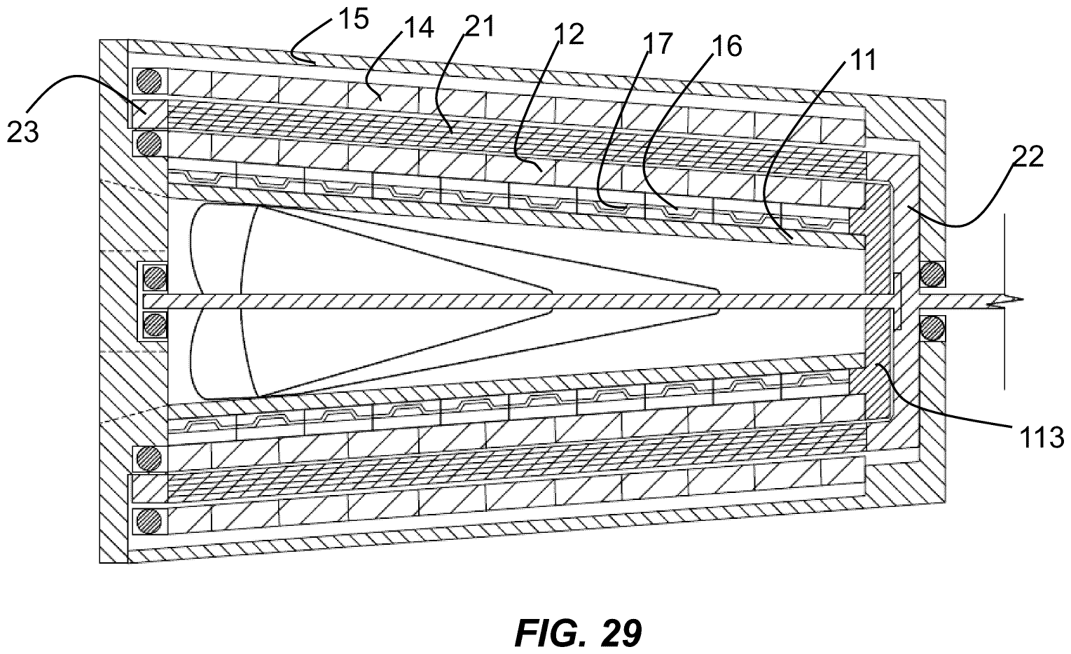

The electromagnets can include stator projections 161 which are arranged longitudinally or arrayed on an outer circumference of an electromagnet stator 16 as shown in FIGS. 29A-30. This is especially useful for stepper motors, EV motors, and three-phase and AC generator applications described in more detail in subsequent applications.

The electrification of the electromagnet components can be carried out by a controller or by simply allowing a small amount of the increased power being produced from the faster wind to be diverted from the load to the magnets, for conceptual instance, by overcoming a resistance. In this way, the additional adaptability is automatic and solid state, and less dependent on parasitic additional control systems needed by the conventional generators.

### Additional Example Embodiments

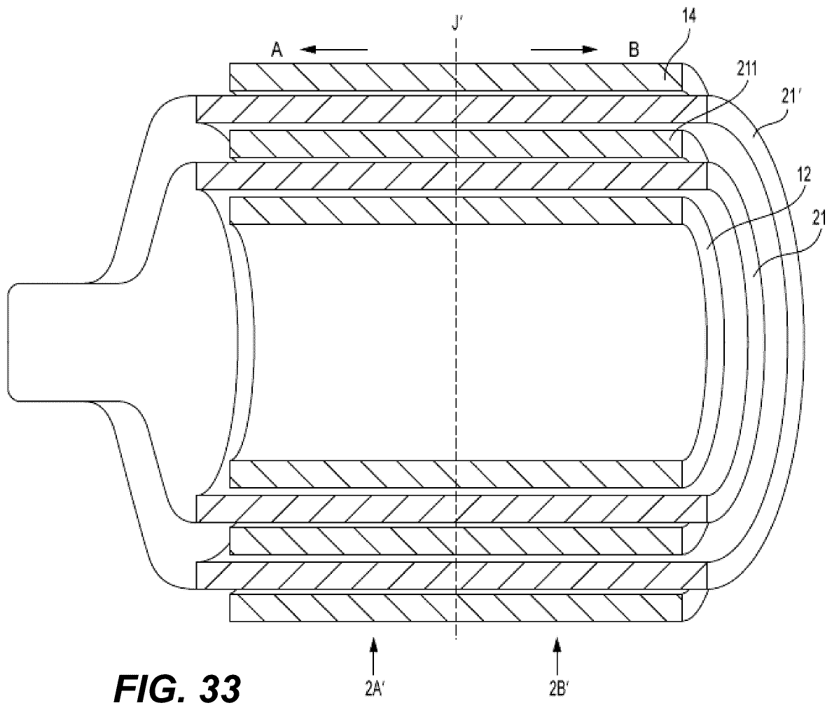

FIGS. 33-35 and 37-42 provide renderings and diagrams of the structures of some additional example embodiments of the present invention. For the sake of brevity, only elements of the additional example embodiments which are different from the above described example embodiments and permutations will be described in detail.

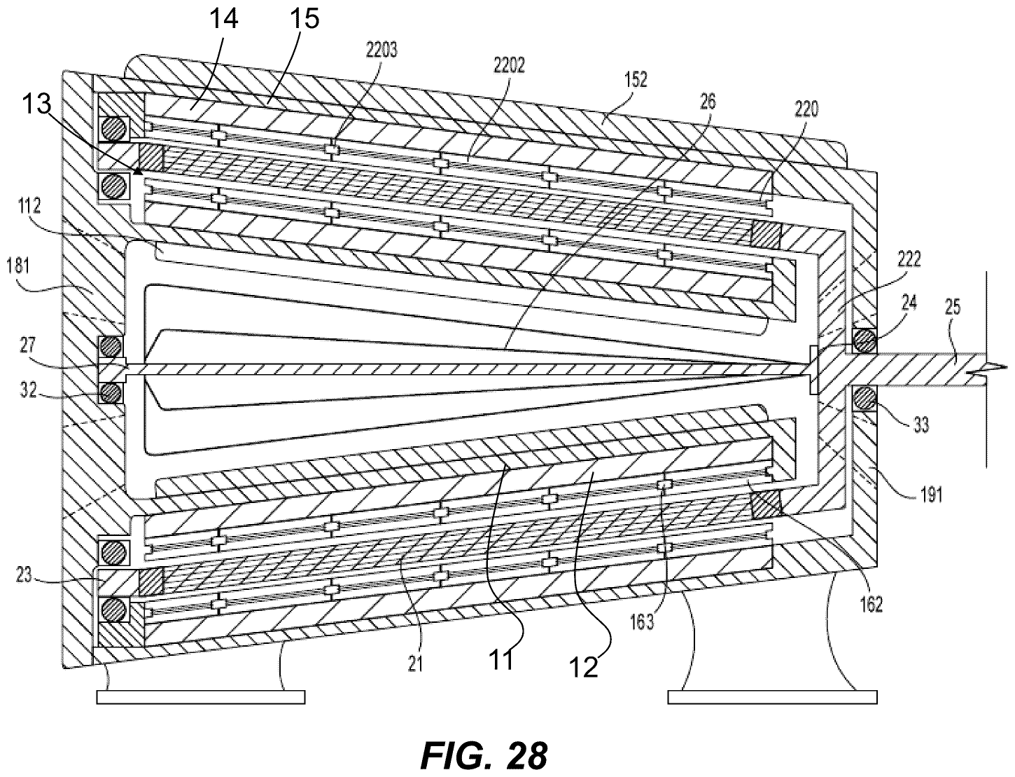

FIG. 28 shows an example embodiment in which the stator assembly 1 preferably includes an inner stator yoke 11 and an outer stator yoke 15 which respectively include an inner electromagnet stator 16 wound with an electromagnetic coil 17 and an outer electromagnet stator 220 wound with an electromagnetic coil 17. The inner stator yoke 11 and an outer stator yoke 15 further respectively include an inner permanent magnet 12 and an outer permanent magnet 14. By using both permanent magnets and electromagnets, the stator assembly 1 is able to have a strong magnetic field produced by the permanent magnets which can also be adjusted by changing the current flowing through the electromagnetic coils 17 of the inner electromagnet stator 16 and the outer electromagnet stator 220.

The example embodiment of FIG. 28 also shows that surfaces of the inner stator yoke 11 and the outer stator yoke 15 may include cooling fins. Further, the housing upper end preferably includes upper ventilation openings 181, the housing lower end 19 preferably includes lower ventilation openings 191, and the rotor support frame 22 preferably includes rotor ventilation holes 222. The upper ventilation openings 181, the lower ventilation openings 191, and the rotor ventilation holes 222 permit an airflow to be directed through the central tube 111 by the fan 26 to further aid in cooling.

FIG. 29 shows an example embodiment in which the stator assembly 1 preferably includes an inner stator yoke 11 which includes an inner electromagnet stator 16 wound with an electromagnetic coil 17 and an inner permanent magnet 12 which is defined by a plurality of laterally stacked permanent magnet ring frustum elements. The outer stator yoke 15 preferably includes an outer permanent magnet 14 which is defined by a plurality of stacked permanent magnet elements.

FIG. 30 shows an example embodiment in which the stator assembly 1 preferably includes an inner electromagnet stator 16 wound with an electromagnetic coil 17 (the inner electromagnet stator 16 could be defined by a permanent magnet with projections 161), an inner permanent magnet 12 which is defined by a plurality of stacked permanent magnet elements, a middle stator 221 which includes permanent magnets 2211, an outer permanent magnet 14 which is defined by a plurality of stacked permanent magnet elements, and an outer electromagnet stator 220 wound with an electromagnetic coil 17.

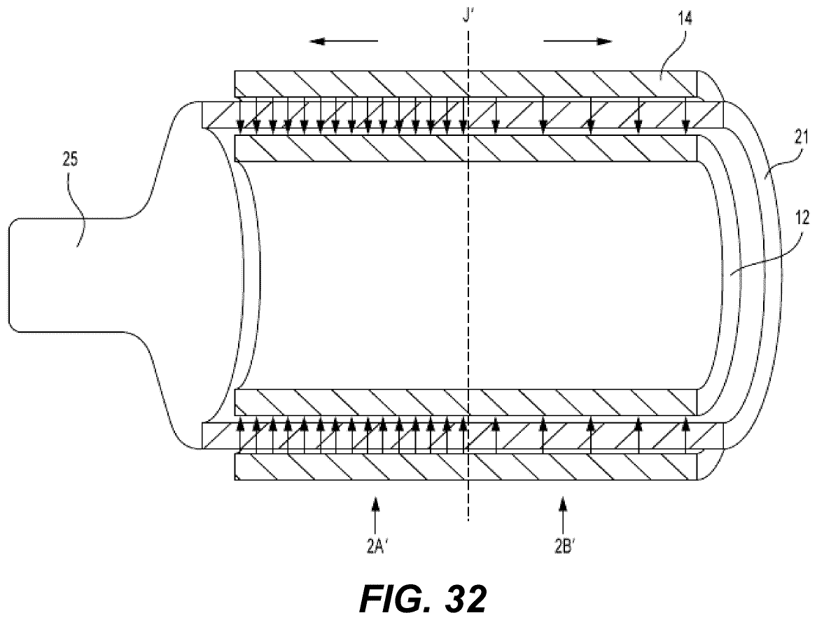

FIG. 32 shows an example embodiment in which a rotor conductor array 21 is rotated between an outer permanent magnet 14 and an inner permanent magnet 12 which include different gradient magnetic field strength areas 2A′ and 2B′ which are separated at a dividing line J′. With this arrangement, the left side of the rotor conductor array 21 cuts through a greater density of flux than the right side, causing it to cut in and ramp up power production at a lower rpm than the right side. This makes its output and the force needed to accelerate it more responsive to changing rpm. There can be multiple gradient magnetic field strength areas, not just two. Further, the field strength could also change in an analog gradient fashion longitudinally.

FIG. 33 shows an example embodiment in which a rotor 2 including an inner conductor array 21 and an outer conductor array 21′ is rotated between air gaps 13 defined between an outer permanent magnet 14, a middle permanent magnet 221, and an inner permanent magnet 12 which each include different gradient magnetic field strength areas 2A′ and 2B′ which are separated at a dividing line J′. With this poly rotor iteration, while each rotor conductor array 21 and 21′ has the same rpm, each travels a different distance and a different speed to make each revolution. Therefore, the outer rotor array 21′ material will go farther and faster around each revolution than the inner rotor array 21 material.

If both inner and outer stator air gap fields 13 have the same flux density, the outer rotor 21′ will kick in sooner and ramp up power production at a lower RPM increasing the way power output varies with changes in rpm, e.g., at a certain speed the outer rotor 21′ has kicked in but the inner rotor 21 is not yet producing meaningful power. At a higher rpm, now the air gap fields both are producing meaningful power thus adding additional adaptability, each of these separate rotor's fields can be of different intensities, plus each can vary longitudinally as long as they are homogenous circumferentially.

In FIG. 33, the longitudinal difference is divided into the gradient magnetic field strength areas 2A′ and 2B′. Now there are 4 distinct regions including outer rotor 2A′ and 2B′ as well as inner rotor 2A′ and 2B′. Each distinct region kicks in and starts ramping up power production at a specific rpm. This further widens the range of responsive change in power production as the rate with which the rotors are spun varies.

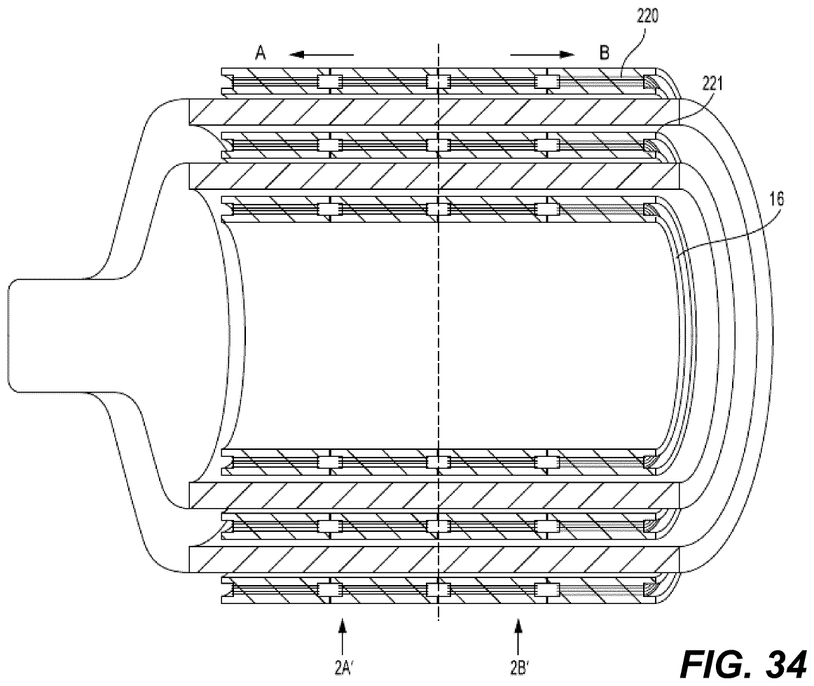

FIG. 34 shows an example embodiment in which a rotor 2 including a conductor array 21 and an outer conductor array 21′ is rotated between two air gaps 13 defined between an outer electromagnet stator 220, a middle electromagnet stator 221, and an inner electromagnet stator 16 which are each able to produce different gradient magnetic field strength areas 2A′ and 2B′ which are separated at a dividing line J′. The two airgaps 13 define four flux regions, two for each of the opposed stator arrangements (e.g., in the 4 distinct regions: outer rotor 2A′ and 2B′ as well as inner rotor 2A′ and 2B′). Further, 2A′ and 2B′ can be further split into different strength field sections by differentially powering the electromagnet of the stator. The electromagnets of the stator could also be hybrid combined permanent and electromagnet magnets.

Now, the stator field intensity for each segment can be individually increased or decreased through the electromagnets. This confers multiple changes, for both when this machine is used as a generator and when used as a motor. Focusing on the generators used for wind power, and that when the wind speed rises there is more power to harvest, conventional generators have to waste the lucrative power to prevent overspin of the generator or blade tips. In this generator, before either overspin phenomena can happen, and as the power output ramps up (in addition to the increased resistance to acceleration conferred by the different radii areas of rotor, different areas of baseline magnetic field strengths, different rotor thicknesses and air gaps, etc.), the final protection against over spin is that some of the large extra power output can be diverted to the electromagnet coils, increasing the stator field intensity to its maximum in all segments. This increases the flux that is being transected by the rotors, increasing both the power output but also increasing the amount of force needed to spin and accelerate the generator/turbine. This prevents or forestalls overspin.

FIG. 35 shows an example embodiment in which a rotor 2 including an inner conductor array 21 and an outer conductor array 21′ is rotated between air gaps 13 defined between an outer hybrid electro/permanent stator 220, a middle hybrid electro/permanent stator 221, and an inner hybrid electro/permanent stator 16 which are each able to produce different gradient magnetic field strength areas 2A′-2C′ which are separated at a dividing line J′ and J″.

The above structures and arrangements increase the voltage from the smaller diameter rotor such that it can be more equal to that produced by the larger diameter rotor by varying the flux density, but also by virtue of the longer inner assembly. Having the rotors concentrically positioned also saves on magnet cost and weight. It also multiplies the device power density by making it more compact. It also gives the device a conical shape that is of small aerodynamic advantage.

In FIG. 35 there are three zones of differing baseline magnetic strength (A, B, C) surrounding 2 different diameter/different length rotor conductor arrays (inner 21 and outer 21′). In this configuration there are five zones with different cut in/ramp up characteristics (A/inner rotor, A/outer rotor, B/inner rotor, B/outer rotor, C/inner rotor). Each of these 5 zones contribute to the adaptability because each has a different output/rpm curve based on their individual rotor diameter and magnetic field strength.

Next, a control system which selectively energizes the windings of the electromagnetic components of stators 16, 221, and 220 will be described. With the ability to power each circumferential band of the electromagnetic components of stators 16, 221, and 220, the number of adaptability zones increases, i.e., Section A, as drawn, has 2 electromagnet circumferential bands. If only one is energized, or if they are energized unequally, section A becomes two different sections (A and A prime). So there a total of 10 different zones, for example. Each of these zones have a unique radius to field strength ratio, so taken together, they impart a cone-like variability termed functional conicity.

Each circumferential section can be magnetized not just to one different fixed level of field strength, but to anywhere within a range of multiple magnetic field strengths, so it is not limited to 10 single fixed options for the adaptability/generative/braking characteristics.

In addition, with algorithmic varying of specific circumferential field strengths, a generator corresponding to FIG. 35 can adapt to conditions in a different way. For example, on a high speed wind day, the electromagnets can all be energized uniformly to their maximum to harvest the most power while providing the greatest protection against over spin. Also, on a gusty day, the magnets can be energized with some toward their maximal range and others toward the minimal and the rest in a gradient stratification so as to create a wide spectrum range of different operating parameters so the generator has had its adaptability maximized and it is ready for the highly variable gusty input. On a light wind day, in a case that the stator includes both permanent magnets and electromagnets, the electromagnetic input can be shut off such that the magnetic field in the airgaps 13 of the generator becomes its weakest and easy to spin rating and continues to harvest that range also. Under more constant mid wind speed conditions, the various segments will be adapted to have flux field strengths that improve or optimize output for that input. That is, each segment will be controlled to have the flux density to diameter ratio optimized for maximal output and appropriate braking. For example the inner rotor, traveling less than the outer rotor per rotation will have the field made stronger than that of the outer rotor. Another way of saying this is the two will be made to have the same rotor circumference to flux transection ratio so they will contribute in a balanced fashion.

Note that this electromagnetic control is also applicable to motors, especially EV motors that encounter a tremendously variable set of operating conditions as the car accelerates and decelerates, goes up and down hills, and carries a varying load of occupants and cargo.

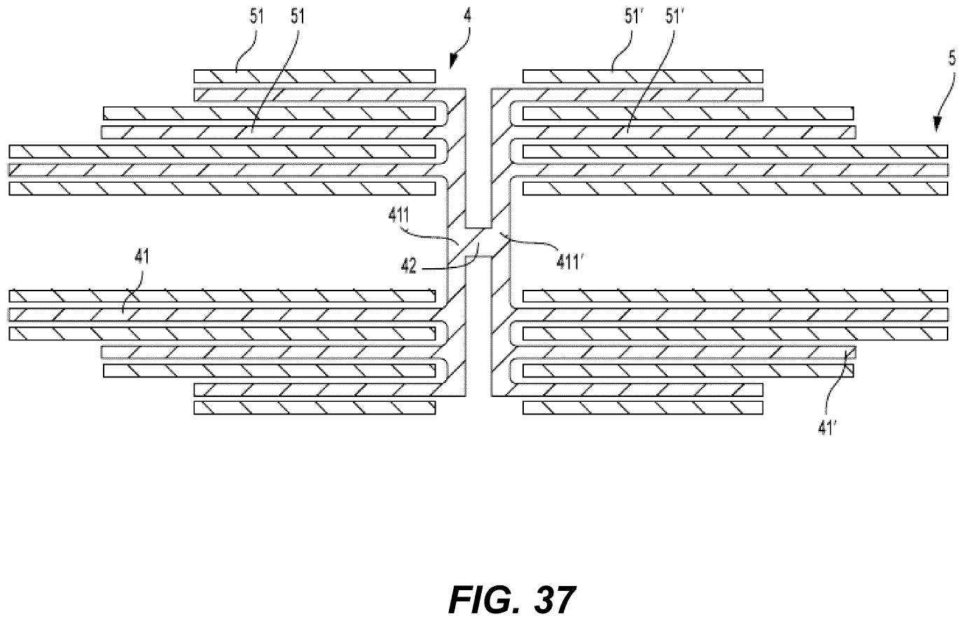

FIG. 36 shows an example embodiment in which a lateral double rotor assembly 6 interacts with a lateral double stator assembly 7. The double rotor assembly 6 includes upper rotor disks 61 which are mutually connected to one side of a common connecting shaft 62, and lower rotor disks 61′ which are mutually connected to another side of the common connecting shaft 62. The double stator assembly 7 includes upper stator magnets 71 and lower stator magnets 71′ which are opposed to the upper rotor disks 61 and the lower rotor disks 61′. Note that these disks could be replaced with drums, similar as to what is shown in FIG. 37.

An insulating shaft insert (preferably made of non-electrically conductive resin or non-electrically conductive metal) is preferably provided between the one side of the common connecting shaft 62 and the another side of the common connecting shaft 62 and a transformer or similar component 9 is provided, for example, with input leads 91 connected to the opposing ends of the lateral double rotor assembly 6 is able to provide an output current through output leads 92. The input leads 91 are preferably connected to the opposing ends of the common connecting shaft 62 through brushes or some other rotational connector. While not shown in this figure, the periphery of the left disks is preferably electrically coupled to the periphery of the right disks. The directly generated low voltage/high amperage electrical energy goes in a circle path with the load being the transformer or similar component 9.

It is important to note that the polarity of the magnetic fields are reversed from the left side to the right side in FIG. 36. In this side view, there are six spinning rotor disks (61 and 61′) affixed to, and electrically coupled with the same single axle/spindle rod 62. But for the novel manner of dealing with brush losses to be discussed later, the entirety of the six disks 61 and 61′ and the axle rod could be cast as a single piece from a suitably conductive material and the transformer or similar component 9 would be moved to the connecting wire on the disk periphery. It is also the only moving piece. In this iteration the disks 61 and 61′ have been made with different diameters to confer extra adaptability. All but the end disk magnets 71 and 71′ include a hole in the center to allow the axel rod to pass through. They all are arranged so opposite poles oppose each other across an inter magnet space, which is occupied by the spinning rotor disks 61 and 61′. Note that the group of magnets 71 on the left side are preferably positioned so that south magnetic pole is to the left and north magnetic pole is to the right, while the right sided group of magnets 71′ is positioned so north magnetic pole is to the left and south magnetic pole is to the right. This way, when the axle 62 and rotor 6 are spun, on the left group, electrons are induced to flow from the periphery of the disk to the center and out into the rod. On the right hand side, while the disks rotate in the same direction as those on the left, the magnetic field polarity is reversed so the electrons are induced to flow from the central rod to the periphery of the disks. The magnets can be electro mags or hybrid or permanent magnets in dc versions, and electromagnets in AC versions. While each side's group of disks can be thought of being arranged in parallel so their individual amperage adds together, the two groups are connected in series so the voltages add.

Current collecting brushes (not shown) preferably touch the outer circumferential edges of the disks 61 and 61′. There are several advantages to this layout. The first is reduced brush loss. Sliding brushes collect current but at a penalty of voltage loss.

The more important concept here comes from examining the non-conductive insulating shaft insert 8 and the transformer 9. When the system is an AC generator, the current in the rod 62 now has to pass through a primary winding 91 of the transformer 9 (preferably a step up transformer). For simplicity and lack of vibration, understand the transformer 9 to be a cylindrical transformer built uniformly, circumferentially around the rod axle 62 which rotates together with the rod 62. The high voltage power is taken from the secondary transformer coil 92 via, for example, slip rings or the like.

It is possible to construct a similar system for a generator that uses permanent magnets. The internal circuit can be low voltage DC and the power can go through an internal inverter/converter. Alternatively, one set of the rotor disks/drums 61 and 61′ can have intermittent nonconductive areas built into their outer rims that intermittently interrupt the flow of the dc current. During the off times, the surplus charge is stored in the disks 61 and 61′ and delivered during the on times, as is known to occur with homopolar designs. The dc current flashing on and off can activate a suitably built step up transformer or similarly functioning inverter.

FIG. 37 shows an example embodiment in which a longitudinal double rotor assembly 4 interacts with a longitudinal double stator assembly 5. The double rotor assembly 4 includes upper rotor cups 41 which are mutually connected to an upper base 411, and lower rotor cups 41′ which are mutually connected to an lower base 411′. The lower base 411′ is connected to the upper base 411 through a common connecting shaft 8. The longitudinal double stator assembly 5 includes upper stator magnets 51 and lower stator magnets 51′ which are opposed to the upper rotor cups 41 and the lower rotor cups 41′.

Again, similarly to FIG. 36 but not shown, there could be an internal step up transformer with the primary circuit of low voltage, high amperage primary output traveling only the very short, circular path from the rotor drums 41 and 41′ through the primary transformer winding and back to the rotor drums 41 and 41′. The power induced in the secondary transformer coil leaves the generator. In example embodiments for DC, again, an inverter can substitute for the transformer.

It should be understood that the foregoing description is only illustrative of example embodiments of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. A dynamoelectric machine comprising:
a magnet layer to generate a magnetic field;
a conductor affixed to the magnet layer; and
a yoke radially inward or radially outward from the magnet layer and the conductor; wherein
the magnet layer and the yoke have a conical shape with a changing radial thickness along an axis of the dynamoelectric machine; and
a first axial end of the magnet layer has a smaller diameter than a second axial end of the magnet layer.

2. The dynamoelectric machine according to claim 1, wherein the magnet layer includes permanent magnet components.

3. The dynamoelectric machine according to claim 1, wherein
the conductor includes a main copper component and is embedded with or contacts an outer surface of the magnet layer.

4. The dynamoelectric machine according to claim 1, wherein the magnet layer includes longitudinally extending bars.

5. The dynamoelectric machine according to claim 4, wherein the longitudinally extending bars are arc-shaped.

6. The dynamoelectric machine according to claim 1, wherein the magnet layer includes electrically conductive magnetic material.

7. The dynamoelectric machine according to claim 1, wherein a plurality of the magnet layers and a plurality of the conductors are provided.

8. The dynamoelectric machine according to claim 1, further comprising:
an additional yoke radially opposed to the yoke; wherein
the magnet layer and the conductor are provided radially between the yoke and the additional yoke.

9. The dynamoelectric machine according to claim 1, wherein a plurality of the magnet layers are provided, the conductor being located radially between the plurality of the magnet layers.

10. A dynamoelectric machine comprising:
a rotating structure including connected layers of ferrous material and electrically conductive material; wherein
the ferrous material is provided radially adjacent to the electrically conductive material; and
the rotating structure has a conical shape with a changing radial thickness along an axis of the dynamoelectric machine; and
a first axial end of the rotating structure has a smaller diameter than a second axial end of the rotating structure.

11. The dynamoelectric machine according to claim 10, wherein the electrically conductive material includes a main copper component and is embedded with or contacts an outer surface of the ferrous material.

12. The dynamoelectric machine according to claim 10, wherein the ferrous material is electrically conductive.

13. The dynamoelectric machine according to claim 10, wherein a plurality of layers of the ferrous material and a plurality of layers of the electrically conductive material are provided.

14. The dynamoelectric machine according to claim 10, further comprising:
a pair of yokes radially opposed to one another; wherein
the ferrous material and the electrically conductive material are provided radially between the pair of yokes.
